(19) United States
(12) Patent Application Publication
(10) Pub. No.: US 2015/0292924 A1
(43) Pub. Date: Oct. 15, 2015

(54) ROTATION NUMBER MEASUREMENT DEVICE, ROTATION NUMBER MEASUREMENT METHOD, AND FLOW RATE MEASUREMENT DEVICE

(71) Applicant: Renesas Electronics Corporation, Kawasaki-shi (JP)

(72) Inventor: Naoyuki SHIRAISHI, Kawasaki-shi (JP)

(73) Assignee: RENESAS ELECTRONICS CORPORATION, Kawasaki-shi (JP)

(21) Appl. No.: 14/666,506

(22) Filed: Mar. 24, 2015

(30) Foreign Application Priority Data
Apr. 15, 2014 (JP) 2014-083752

(51) Int. Cl. G01F 1/60; G01F 1/58

(52) U.S. Cl. CPC G01F 1/60; G01F 1/582

(57) ABSTRACT

A rotation number measurement device includes a detection circuit for generating a signal that differs depending on whether a first area is near or a second area is near by rotation of a rotating plate, a determination circuit which receives the signal of the detection circuit and a reference value and determines the signal based on the reference value, a counting circuit for obtaining a count indicating that a determination of the determination circuit with a first period during a first duration is a signal corresponding to the first area, and a reference circuit for generating the reference value so that a ratio between a count indicating that a determination of the determination circuit with the first period during the first duration is a signal corresponding to the second area and the count of the counting circuit becomes equal to a ratio between the second area and the first area.

### CROSS-REFERENCE TO RELATED APPLICATIONS

The disclosure of Japanese Patent Application No. 2014-083752 filed on Apr. 15, 2014 including the specification, drawings and abstract is incorporated herein by reference in its entirety.

### BACKGROUND

The present invention relates to a rotation number measurement device, a rotation number measurement method, and a flow rate measurement device, and particularly to the rotation number measurement device using a semiconductor integrated circuit device incorporating a central processing unit, the rotation number measurement method, and the flow rate measurement device.

Flow rate measurement devices include water meters for measuring the flow rate of tap water flowing through a water pipe. Typical water meters include measurement devices for mechanically measuring the flow rate and measurement devices for electronically measuring the flow rate. For example, Japanese Unexamined Patent Publication No. 2013-156207 (Patent Document 1) discloses a technique for a flow rate measurement device for electronically measuring the flow rate. In Japanese Unexamined Patent Publication No. 2013-156207, a metal part and an insulating part are provided on a circular plate which rotates in accordance with the flow of tap water, a coil is provided near the circular plate, and the number of rotations of the circular plate is determined using a voltage, from the coil, which differs depending on whether the metal part of the circular plate is near or the insulating part is near, thereby calculating the flow rate of the tap water.

### SUMMARY

In the technique disclosed in Japanese Unexamined Patent Publication No. 2013-156207, the voltage from the coil is compared with a reference voltage by a comparator, and converted into a digital signal. That is, the reference voltage is used as a threshold, and based on the threshold, the voltage from the coil is converted into the digital signal. Arithmetic processing is performed on the digital signal obtained by conversion, and the flow rate is obtained.

In this case, an inappropriate threshold makes it difficult to convert the voltage from the coil into an appropriate digital signal, and it becomes necessary to increase the number of samplings to acquire the rotation position of the circular plate. Further, an inappropriate threshold might prevent sampling and conversion into the digital signal. This prevents the flow rate from being measured.

On the other hand, the threshold changes due to the temperature characteristic of a generation circuit (element) for generating the threshold, a secular change of the generation circuit (element) and/or component variations including element characteristic variations. Such component variations can be detected, for example, by inspection before the shipment of the measurement device, and countermeasures can be taken by shipping only measurement devices having the appropriate threshold, which however decreases the yield of the measurement device. Further, by measuring the temperature characteristic and voltage characteristic of the generation circuit (element) beforehand, a characteristic table for compensation can be created and incorporated into the measurement device or the like beforehand for countermeasures. In this case, work for creating the characteristic table beforehand is required. Further, in this case, it is required that the compensation based on the characteristic table is performed while the measurement device is operating.

In Japanese Unexamined Patent Publication No. 2013-156207, a change in the threshold and countermeasures against an inappropriate threshold are not considered.

The other problems and novel features will become apparent from the description of this specification and the accompanying drawings.

According to one embodiment, a rotation number measurement device is coupled to a rotator including first and second areas having different characteristics and measures the number of rotations of the rotator. The rotation number measurement device includes a detection circuit for generating a signal that differs depending on whether the first area is near or the second area is near by rotation of the rotator and a determination circuit which receives the signal generated by the detection circuit and a threshold (hereinafter also referred to as a reference value) and determines the signal based on the reference value. Further, the rotation number measurement device includes a counting circuit for obtaining a count indicating that a determination performed by the determination circuit with a first period during a first duration is a signal corresponding to the first area and a reference value generation circuit for generating the reference value so that a ratio between a count indicating that a determination performed by the determination circuit with the first period during the first duration is a signal corresponding to the second area and the count obtained by the counting circuit becomes equal to a ratio between the second area and the first area. The rotation number measurement device determines a signal generated by the detection circuit, using the reference value generated by the reference value generation circuit and calculates the number of rotations of the rotator during a second duration different from the first duration.

The reference value generation circuit sets the reference value supplied to the determination circuit so that the ratio between the number of determinations, by the determination circuit, of the signal corresponding to the first area and the number of determinations of the signal corresponding to the second area becomes equal to the ratio between the first area and the second area. This makes it possible to obtain an appropriate reference value and obtain the number of rotations of the rotator based on the appropriate reference value during the second duration. This can prevent an increase in the number of samplings and accordingly prevent an increase in the power consumption of the rotation number measurement device.

Further, according to the one embodiment, the operation period of the determination circuit during the first duration for obtaining the reference value is set to be shorter than the operation period of the determination circuit during the second duration for calculating the number of rotations. This makes it possible to improve the accuracy of determination by the determination circuit during the first duration and obtain a more appropriate reference value. Further, it is possible to set the first duration to be shorter than the second duration for calculating the number of rotations and therefore suppress an increase in power consumption as a whole.

According to one embodiment, a rotation number measurement method is provided. The rotation number measurement method has a calibration duration for calibrating a reference value and a rotation number measurement duration executed after the calibration duration. In this embodiment, the reference value calibrated during the calibration duration is used during the rotation number measurement duration, which can provide an accurate measurement result. During the calibration duration, the number of determinations of a signal corresponding to a first area and the number of determinations of a signal corresponding to a second area are obtained based on the reference value, and the reference value is calibrated so that a ratio between the obtained number of determinations corresponding to the first area and the number of determinations corresponding to the second area corresponds to a ratio between the first area and the second area. On the other hand, during the measurement duration, a signal generated by rotation of the rotator is determined based on the calibrated reference value, and the number of rotations of the rotator is calculated. This makes it possible to obtain the appropriate reference value calibrated during the calibration duration and perform an accurate determination without increasing the number of samplings during the measurement duration.

Further, according to the one embodiment of the rotation number measurement method, if a change in the number of rotations of the rotator is within a predetermined range, the reference value is calibrated. This makes it possible to calibrate the reference value when there is not a large change in the number of rotations, that is, the rotator is rotating at constant speed.

According to one embodiment of a flow rate measurement device, a rotator rotates in accordance with a flow of fluid. A flow rate is obtained by the number of rotations of the rotator. In this embodiment as well, a reference value is set so that a ratio between the number of determinations corresponding to a first area and the number of determinations corresponding to a second area corresponds to a ratio between the first area and the second area. This makes it possible to set the appropriate reference value, suppress an increase in the number of samplings, and suppress an increase in power consumption.

Further, it is to be understood that the term “near” or “close to” includes the term “directly under” in this specification.

According to the one embodiment, it is possible to provide the rotation number measurement device that can improve measurement accuracy and suppress an increase in power consumption.

### BRIEF DESCRIPTION OF THE DRAWINGS

FIG. 1 is a schematic diagram showing the configuration of a water meter as an example of measuring a flow rate.

FIGS. 2A to 2D are explanation diagrams for explaining the principle of measuring the number of rotations.

FIGS. 3A to 3D are explanation diagrams for explaining the principle of measuring the number of rotations.

FIGS. 4A and 4B are waveform diagrams showing response signals from a sensor.

FIGS. 5A to 5D are explanation diagrams showing the relationship between the envelope curve of the response signal and a threshold.

FIG. 6 is a graph showing the change of the flow rate of tap water flowing through a water pipe.

FIGS. 7A and 7B are explanation diagrams showing the relationship between the change of the threshold and the number of samplings.

FIG. 8 is a block diagram showing the configuration of a water meter according to an embodiment.

FIGS. 9A to 9G are operation waveform diagrams according to the embodiment.

FIGS. 10A and 10B are explanation diagrams for explaining the embodiment.

FIG. 11 is flowchart showing the operation of the embodiment.

FIGS. 12A to 12F are explanation diagrams showing a modification.

### DETAILED DESCRIPTION

Hereinafter, embodiments of the present invention will be described in detail with reference to the drawings. In all the drawings for illustrating the embodiments, the same sections are basically denoted by the same reference numerals, and their description will not be basically repeated.

A rotation number measurement device that is used as, e.g., a water meter will be described in the following embodiment. In the case of use as the water meter, for example based on the number of rotations during a predetermined time and a flow rate per rotation, the flow rate of tap water is calculated from the measured number of rotations. As a matter of course, the rotation number measurement device is not limited to use as the water meter, and includes various utilization forms. For example, in consideration of application to the measurement of the flow rate of fluid, the rotation number measurement device can be used in measuring the flow rate of gas.

To facilitate understanding, the basic configuration and operation of the rotation number measurement device that is used as the water meter will first be described.

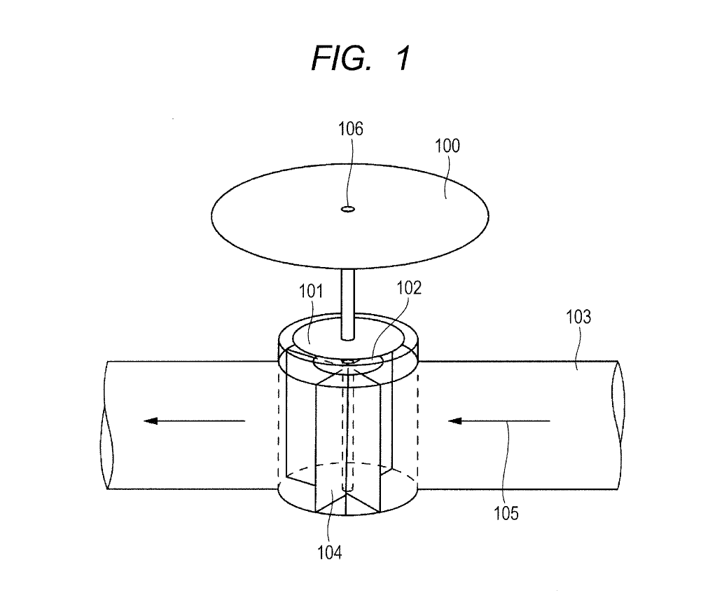

FIG. 1 is a schematic diagram showing the configuration of the water meter. In the example of FIG. 1, tap water flows through a water pipe 103 in the direction of an arrow 105. A vane wheel 104 is provided in the water pipe 103, and rotates when the tap water flows. Although not restricted, the vane wheel installation part of the water pipe 103 is enlarged so that the vane wheel 104 can be provided. Further, the vane wheel 104 is closely provided to the water pipe at the installation part so that the vane wheel 104 can rotate even when the tap water flows slowly. The rotating shaft of the vane wheel 104 is fixed to the rotating shaft of a circular plate 102 provided at the installation part of the water pipe 103, so that the rotation of the vane wheel 104 is conveyed to the circular plate 102. A circular plate 101 is provided over the vane wheel installation part. A wall of the water pipe exists between the circular plate 101 and the circular plate 102, so that the circular plate 101 and the circular plate 102 do not touch each other. In this example, the circular plates 101 and 102 are comprised of magnets, and are magnetically coupled to each other. Therefore, the circular plate 102 rotates in accordance with the rotation of the circular plate 101. That is, the rotation of the vane wheel 104 is conveyed to the circular plate 102, and conveyed to the circular plate 101 by magnetic coupling. The rotation of the circular plate 101 is conveyed to a rotating shaft 106 provided in the center of the circular plate 101. The rotating shaft 106 is joined to the center of a rotating plate 100 as a rotator. The rotating plate 100 is shaped like a disc, and rotates by rotation of the rotating shaft 106. Thus, the vane wheel 104 rotates in accordance with the flow of the tap water, and the rotating plate 100 also rotates in accordance with the flow of the tap water. At this time, the number of rotations of the rotating plate 100 is proportional to that of the vane wheel 104.

Although not shown in FIG. 1, a sensor is arranged close to the rotating plate 100, and the number of rotations of the rotating plate 100 during a predetermined time is calculated based on the output of the sensor. Further, the flow rate of the tap water during the predetermined time is calculated based on the calculated number of rotations and a flow rate per rotation of the rotating plate 100.

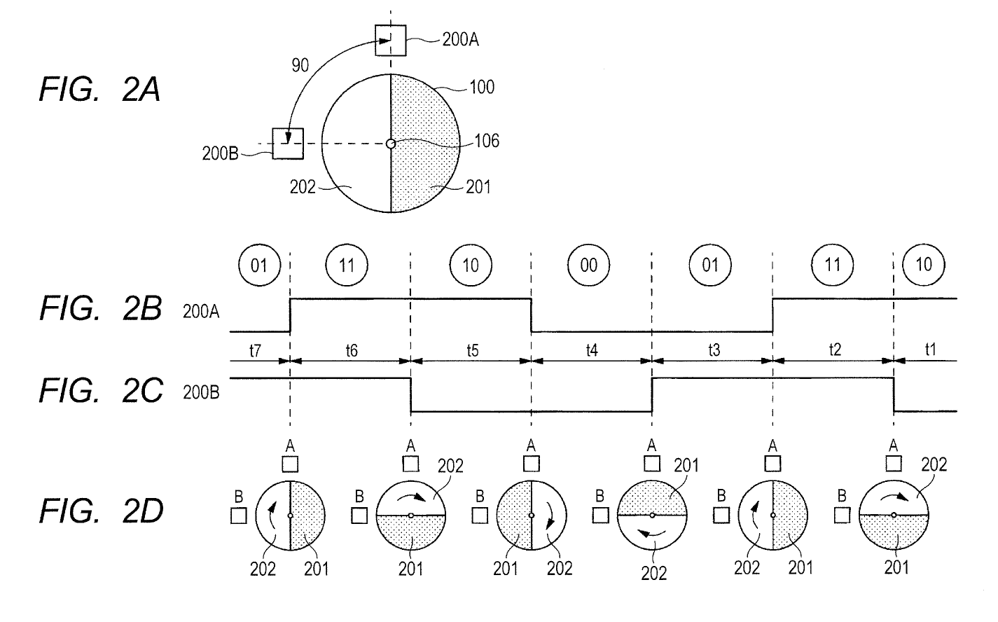

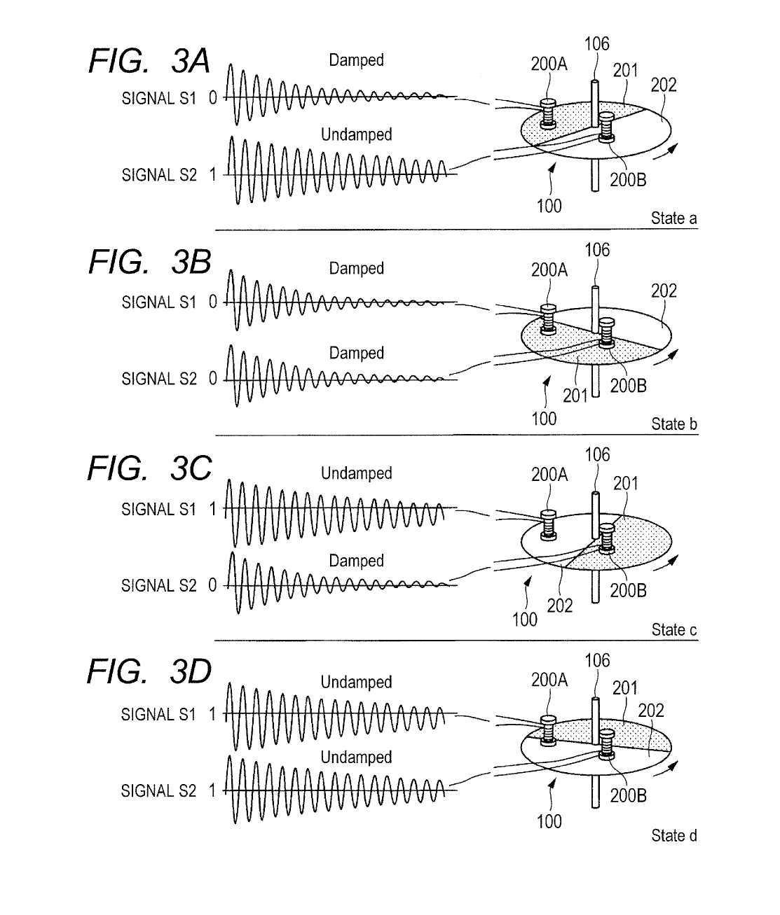

FIGS. 2 and 3 are explanation diagrams for explaining the principle of detecting the rotating state of the rotating plate 100 by the rotating plate 100 and sensors. Next, the principle of detecting the rotating state will be described with reference to FIGS. 2 and 3.

FIG. 2A is a plan view of the rotating plate (rotator) 100. In FIG. 2A, reference numerals 200A and 200B denote sensors arranged close to the rotating plate 100. In FIG. 2A, the sensors 200A and 200B are arranged outside the rotating plate 100 to facilitate visualization; however, in reality, the sensors 200A and 200B are arranged over the main surface of the rotating plate 100 as shown in FIGS. 3A to 3D. That is, as shown in FIGS. 3A to 3D, the sensors 200A and 200B, which are coils, are arranged over the main surface of the rotating plate 100 and separated so as to form an angle of 90 degrees about the center (central shaft 106) of the rotating plate 100.

Further, an electric conductor is arranged in a half area 201 (dotted area) of the main surface of the rotating plate 100, and an insulator is arranged in the other half area 202. For example, a copper plate as a conductor may be arranged in the half area 201 of the main surface of a circular plate formed of an insulating material. More specifically, the copper plate may be printed in the half area of the insulating circular plate.

In this embodiment, the sensors 200A and 200B are coils as shown in FIGS. 3A to 3D. When e.g. a rectangular pulse signal as an initiation signal is supplied to the coils (sensors 200A, 200B), depending on whether the area of the rotating plate 100 near the coil is the conductor area 201 or the insulator area 202, it takes a different amount of time for the voltage of a response signal generated in response to the initiation signal to damp. More specifically, if the near area is the insulator area 202, resonance can occur between the area and the coil, so that the response signal damps slowly. On the other hand, if the near area is the conductor area 201, resonance does not occur, so that the response signal damps quickly. This can also be understood as follows. If the near area is the conductor area 201, an eddy current flows in the conductor part, so that the response signal damps quickly.

In this embodiment, the angular difference between the sensors 200A and 200B is 90 degrees about the central shaft 106, half the area of the rotating plate 100 is the conductor area 201, and the other half is the insulator area 202. Accordingly, by the sensors 200A and 200B, the rotation of the rotating plate 100 can be distinguished into four states (four phenomena). The four states are shown in FIGS. 3A to 3D. In FIGS. 3A to 3D, the horizontal axis indicates the time, and the vertical axis indicates the voltage.

FIG. 3A shows a state where the conductor area 201 of the rotating plate 100 is located close to (including “directly under”, the same applies hereinafter) the sensor 200A and the insulator area 202 of the rotating plate 100 is located close to (including “directly under”, the same applies hereinafter) the sensor 200B by rotation of the rotating plate 100. In this state (State a), resonance occurs between the sensor 200B and the area 202 of the rotating plate 100 by the initiation signal. On the other hand, resonance does not occur between the sensor 200A and the area 201 of the rotating plate 100. As a result, a response signal S1 from the sensor 200A damps quickly. On the other hand, a response signal S2 from the sensor 200B damps slowly by resonance.

Similarly, FIG. 3C shows a state where the area (insulator) 202 of the rotating plate 100 is located close to the sensor 200A and the area (conductor) 201 of the rotating plate 100 is located close to the sensor 200B. In this state (State c), resonance occurs between the sensor 200A and the area 202 of the rotating plate 100 by the initiation signal, so that the response signal S1 from the sensor 200A damps slowly. On the other hand, resonance does not occur at the sensor 200B, so that the response signal S2 from the sensor 200B damps quickly.

Further, FIG. 3B shows a state where the area (conductor) 201 of the rotating plate 100 is located close to the sensors 200A and 200B. In this state (State b), the resonance does not occur between each of the sensors 200A and 200B and the area 201 of the rotating plate 100 when the initiation signal is supplied, so that the response signals S1, S2 from the sensors 200A and 200B damp quickly. Similarly, FIG. 3D shows a state where the area (insulator) 202 of the rotating plate 100 is located close to the sensors 200A and 200B. In this state (State d), the resonance occurs between each of the sensors 200A and 200B and the area (insulator) 202 of the rotating plate 100, so that the response signals S1, S2 from the sensors 200A and 200B damp slowly.

In FIG. 3, the digital value of the response signal with slow damping due to occurrence of resonance is represented as “1”, and the digital value of the response signal with quick damping due to no occurrence of resonance is represented as “0”. That is, in the state of FIG. 3A, the response signals S1, S2 become digital values “0, 1”. In FIG. 3B, the response signals S1, S2 become digital values “0, 0”. In FIG. 3C, the response signals S1, S2 become digital values “1, 0”. In FIG. 3D, the response signals S1, S2 become digital values “1, 1”. In this embodiment, the response signals S1, S2 are voltage signals that are generated in response to the initiation signal, and damp with time even if the resonance occur between the insulator and the coils as the sensors. In terms of damping, the response signals S1, S2 are damped signals (Damped) in any state shown in FIGS. 3A to 3D. However, in FIG. 3, to clearly indicate slow damping due to the resonance, the response signals in resonance are shown as undamped signals (Undamped).

In FIGS. 3A to 3D, an arrow indicates the rotation direction of the rotating plate 100. In FIGS. 3A to 3D, the rotating plate 100 rotates counterclockwise, and from FIG. 3A toward FIG. 3D, the state transitions. Since the rotating plate 100 rotates, the state transitions to FIG. 3A after FIG. 3D, and the above is repeated.

In FIG. 2D, the rotating state of the rotating plate 100 is schematically shown. In FIGS. 2B and 2C, the voltage waveforms of the response signals S1, S2 from the sensors 200A and 200B are shown as digital values. In FIG. 2D, the sensor 200A is shown as “A”, and the sensor 200B is shown as “B”. Further, in FIGS. 2B to 2D, the horizontal axis indicates the time. In FIGS. 2B to 2D, the time varies from right to left, that is, from time t1 to time t7. In this case, the state of the rotating plate 100 in times t1, t5 corresponds to FIG. 3C, the state of the rotating plate 100 in times t2, t6 corresponds to FIG. 3D, the state of the rotating plate 100 in times t3, t7 corresponds to FIG. 3A, and the state of the rotating plate 100 in time t4 corresponds to FIG. 3B. Further, in FIG. 2B, circled numerals denote the digital values of the response signals S1, S2. Further, in FIG. 2D as well, the rotation direction of the rotating plate 100 is indicated by an arrow.

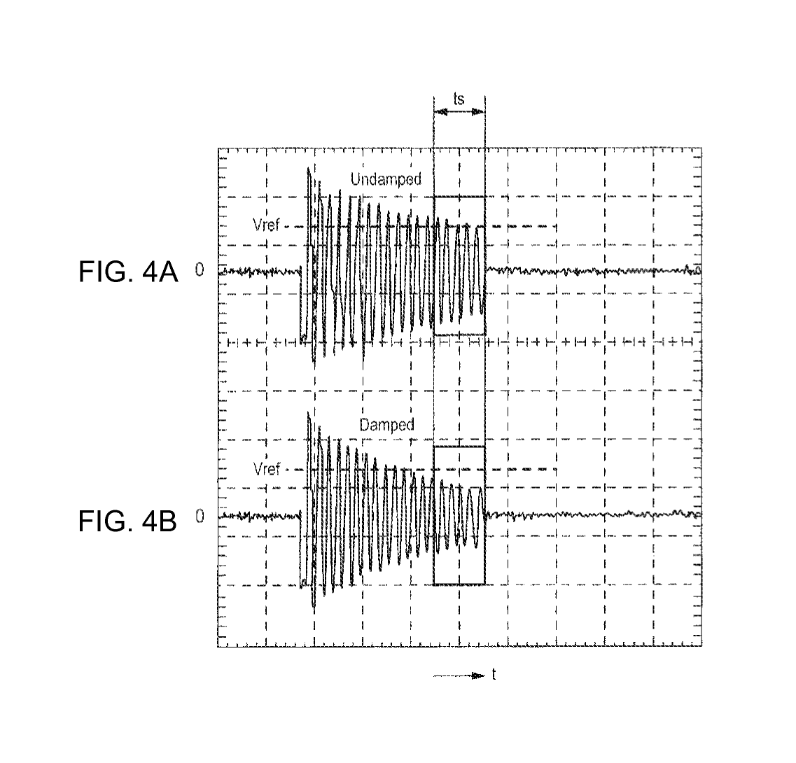

FIGS. 4A and 4B are waveform diagrams showing the voltage waveforms of the response signals S1, S2, in which FIG. 4A shows the voltage waveform of the response signal outputted from the sensor near the insulator area 202 and FIG. 4B shows the voltage waveform of the response signal outputted from the sensor near the conductor area 201. In FIG. 4, the horizontal axis indicates the time, and the vertical axis indicates the voltage. The response signal outputted from the sensor is generated and damps, regardless of whether the conductor area 201 or the insulator area 202 is near. The difference is that if the insulator area is near, the resonance occurs, the amount of damping decreases, and the time required for damping increases.

Accordingly, in this embodiment, although not restricted, the voltage of a threshold (reference value) Vref and the voltage of the response signal are compared during a sampling duration is provided after a lapse of a predetermined time from the generation of the response signal. In this comparison, if the voltage of the response signal exceeds the threshold Vref, it is determined that the sensor that generates this response signal is near the insulator area 202. On the other hand, if the voltage exceeding the threshold Vref is not detected in the comparison, it is determined that the sensor that generates this response signal is near the conductor area 201.

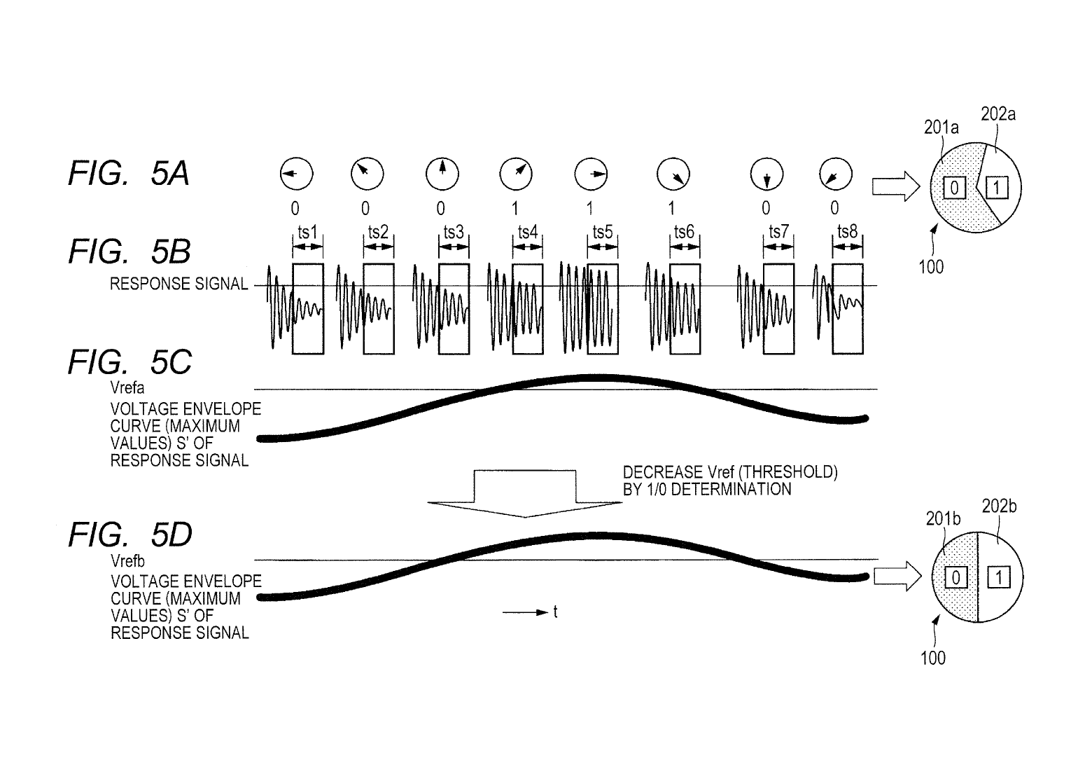

FIG. 5 is an explanation diagram in the comparison of the voltage of the response signal with the voltage of the threshold Vref during the sampling duration is as shown in FIGS. 4A and 4B. In FIG. 5, the horizontal axis indicates the time t. In FIG. 5A, the circle marked with an arrow therewithin schematically represents the rotating plate 100. The apex of the arrow indicates a specific position on the rotating plate 100, and indicates that the specific position rotates as the time t passes. FIG. 5B shows a voltage waveform example of the response signal. The response signal is measured discretely. In FIG. 5B, sampling durations ts1 to ts8 are provided from left to right, and the comparison operation shown in FIG. 4 is performed during each sampling duration.

FIG. 5C shows a threshold voltage Vrefa as the threshold Vref. Further, FIG. 5C shows a voltage envelope curve S′ of the response signal obtained by connecting the maximum values of the response signal in the sampling durations ts1 to ts8. FIG. 5D shows a threshold voltage Vrefb lower than the threshold voltage Vrefa, as the threshold Vref and shows the voltage envelope curve S′ of the response signal shown in FIG. 5C. In FIGS. 5C and 5D, the horizontal axis indicates the time, and the vertical axis indicates the voltage.

If the voltage envelope curve S′ of the response signal shown in FIG. 5C exceeds the threshold voltage Vrefa, the response signal indicates that the sensor is near the insulator area 202. On the other hand, if the voltage envelope curve S′ of the response signal does not exceed the threshold voltage Vrefa, the response signal indicates that the sensor is near the conductor area 201. In the case where the positions of the rotating plate 100 are thus specified, in the sampling durations ts4, ts5, and ts6, the voltage envelope curve S′ of the response signal exceeds the threshold voltage Vrefa, and the digital value becomes “1”. On the other hand, in the remaining sampling durations ts1 to ts3, ts7, and ts8, it is determined that the voltage envelope curve S′ does not exceed the threshold voltage Vrefa, and the digital value becomes “0”. In this example, in the eight sampling durations, the number of digital values determined as “1” is three, and the number of digital values determined as “0” is five. According to the determination of the number of digital values “1”, the area determined as the insulator area 202 becomes less than half (½) of the rotating plate 100. In this example, three-eighths the area of the rotating plate 100 is determined as an insulator area 202a, and the other five-eighths is determined as a conductor area 201a.

That is, although half (½) the area of the rotating plate 100 is set as the conductor area 201 and the other half (½) is set as the insulator area 202, an inappropriate voltage value of the threshold Vref makes it difficult to accurately determine the conductor area 201 and the insulator area 202 based on the digital values “1” and “0”. In this embodiment, the value of the threshold Vref is calibrated so that the ratio between the number of digital values “0” and the number of digital values “1” obtained by comparing the response signal with the threshold Vref during a predetermined duration becomes equal to the ratio between the area 201 set as the conductor and the area 202 set as the insulator in the rotating plate 100.

In the example of FIG. 5, by calibrating the threshold Vref, the voltage of the threshold Vref is changed to the threshold voltage Vrefb lower than the threshold voltage Vrefa, as shown in FIG. 5D. Thus, by decreasing the value of the threshold Vref, the voltage envelope curve S′ of the response signal exceeds the threshold voltage Vrefb, for example, in the sampling duration ts3, so that the digital value changes from “0” to “1” as a result of comparison in the sampling duration ts3. This expands the area determined as the insulator area. Further, the repetition of this operation decreases the threshold Vref, and by comparison in the sampling duration ts7 for example, the digital value changes from “0” to “1”. As a result, based also on the determination numbers of digital values determined as “1” and “0”, the area corresponding to half of the rotating plate 100 is determined as a conductor area 201b, and the other half is determined as an insulator area 202b, as shown in the right part of FIG. 5D. Thus, by calibrating the voltage value of the threshold Vref, it becomes possible to accurately determine the conductor area 201 and the insulator area 202.

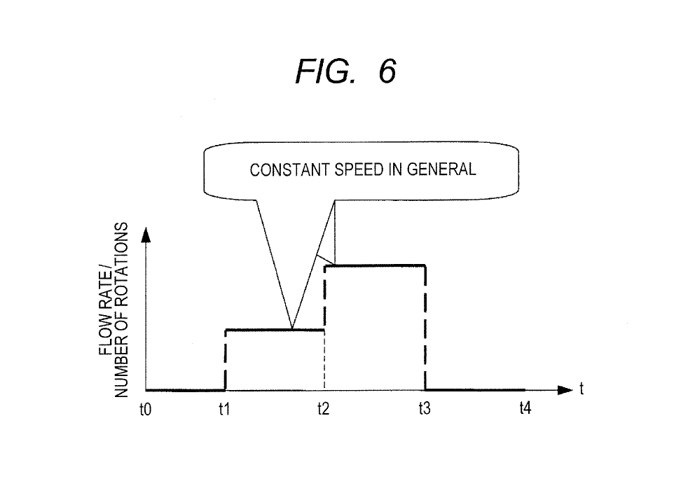

For example, in the case of the tap water, a duration when the flow rate is constant over time is relatively long. FIG. 6 is a graph showing the flow rate of the tap water over time. Since the number of rotations of the rotating plate 100 in the water meter is proportional to the flow rate, the vertical axis in FIG. 6 indicates the flow rate of the tap water and the number of rotations of the rotating plate 100. Further, the horizontal axis indicates the time. As shown in FIG. 6, during times t1 to t3, the flow rate of the tap water flowing through the water pipe increases. Accordingly, the number of rotations of the rotating plate 100 in the water meter increases. However, during a short duration (e.g., times t1 to t2, times t2 to t3), the flow rate of the tap water is approximately constant. That is, the number of rotations of the rotating plate 100 is approximately constant. By calibrating the threshold Vref as described with FIG. 5 during the duration when the flow rate of the tap water (the number of rotations of the rotating plate 100) is approximately constant, it is possible to adjust the voltage value of the threshold Vref to a value matched to the ratio between the conductor area 201 and the insulator area 202 provided in the rotating plate 100.

It is considered that the voltage value of the threshold Vref is predetermined and set at the time of shipment of the measurement device. However, the voltage value of the threshold Vref changes due to, e.g., a change in power supply voltage supplied to the measurement device, a temperature change in a use environment of the device, and/or a secular change.

In the embodiment, as described with FIG. 2A, half the area of the rotating plate 100 is the insulator area 202 determined as the digital value “1”, and the other half is the conductor area 201 determined as the digital value “0”. From another point of view, the conductor area 201 and the insulator area 202 are arranged so as to have an angle of 180 degrees about the center (central shaft 106) of the rotating plate 100.

In the case where the voltage value of the threshold Vref changes due to voltage change, temperature change, and/or secular change when the measurement device is actually used in a state where the conductor area 201 and the insulator area 202 are set in the rotating plate 100 in this manner, the minimum number of measurements of the response signal from the sensor (minimum number of samplings) needs to be increased for appropriate measurement, as exemplified below.

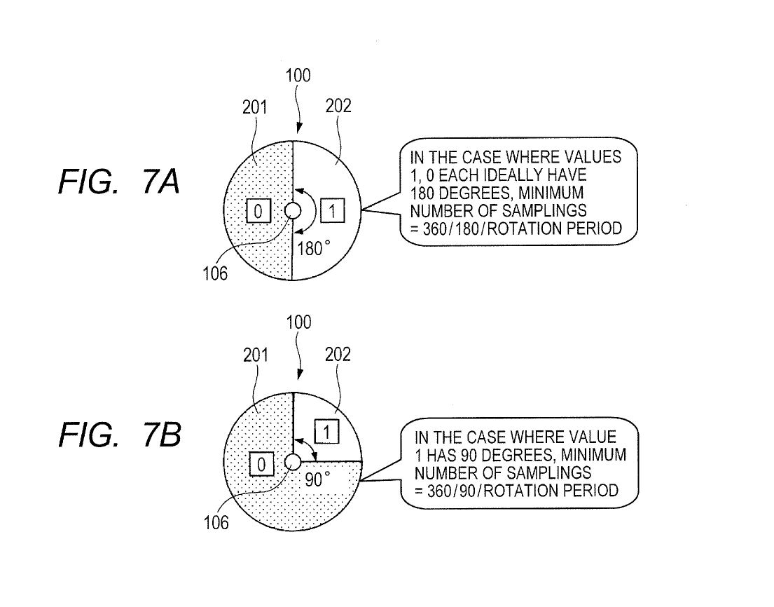

More specifically, assume that the voltage of the threshold Vref changes due to the above reason and it is determined that the insulator area 202 corresponds to 90 degrees instead of 180 degrees as shown in FIG. 7B. In order to be able to always accurately determine this 90-degree state, the minimum number of samplings needs to be preset to 360 degrees/90 degrees/rotation period. The rotation period represents the rotation period of the rotating plate 100. On the other hand, in this embodiment, even if the voltage values of the threshold Vref changes, as described with FIG. 5 the voltage values of the threshold Vref is calibrated so that it is determined that the insulator area 202 and the conductor area 201 each correspond to 180 degrees as shown in FIG. 7A. Accordingly, the minimum number of samplings can be preset to 360 degrees/180 degrees/rotation period.

Thus, even if the voltage value of the threshold Vref changes due to voltage change, temperature change, and/or secular change in actual measurement, in this embodiment, the minimum number of samplings can be preset to a lower value. This can decrease the operation time (sampling operation time) of the measurement device, which can suppress an increase in consumption current.

Further, the threshold Vref might change relatively greatly so that the voltage of the response signal does not exceed the voltage value of the changed threshold Vref in actual measurement. In this case, the digital value is always determined as “0”; accordingly, it is determined that the rotating plate 100 is not rotating, though it is rotating in reality. Therefore, the water meter cannot measure the flow rate. In this case as well, in the embodiment, the threshold Vref is changed as described with FIG. 5, which makes it possible to measure the flow rate.

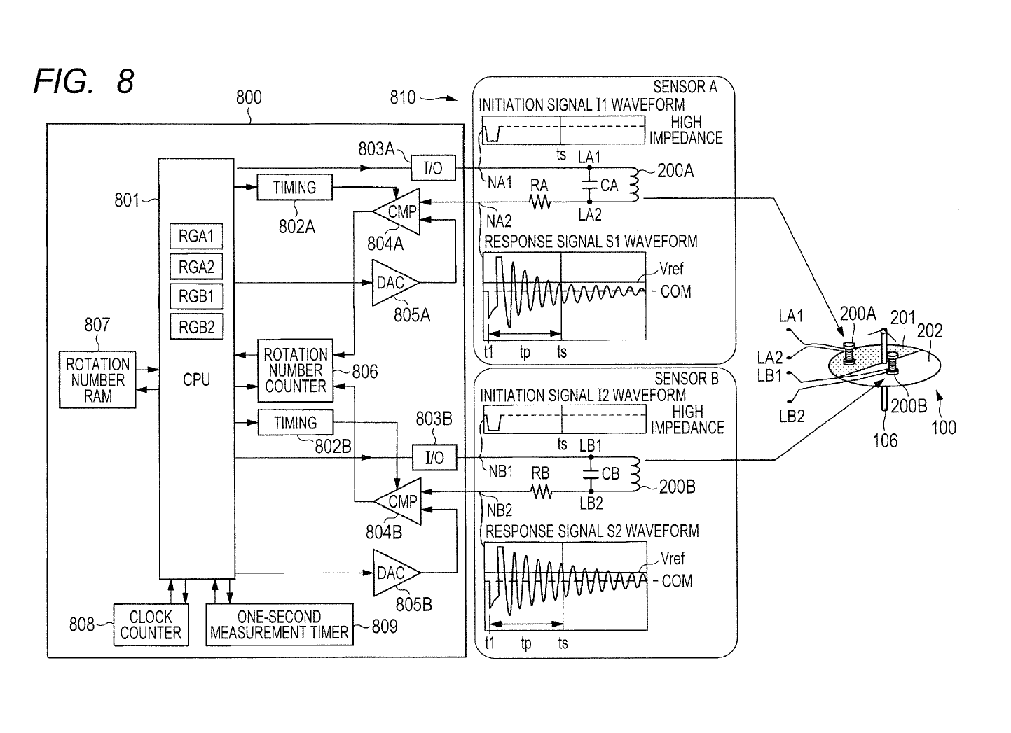

FIG. 8 is a block diagram showing the configuration of a water meter according to this embodiment. The water meter 810 includes the rotating plate 100, a sensor A, a sensor B, and a microcontroller 800. In this embodiment, the microcontroller (hereinafter referred to as MCU) 800 is comprised of one semiconductor integrated circuit device.

The rotating plate 100 is a disc-shaped rotating plate that rotates in accordance with the flow of the tap water, as explained with FIG. 2A etc. The center of the rotating plate is fixed to the central shaft 106, and the central shaft 106 rotates in accordance with the flow of the tap water, so that the rotating plate 100 rotates. The conductor area 201 arranged so as to have an angle of 180 degrees about the center (central shaft 106) of the rotating plate 100 and the insulator area 202 arranged so as to have an angle of 180 degrees as well are provided on the main surface of the rotating plate 100. The conductor area 201 and the insulator area 202 are provided so as not to overlap each other. Thus, the conductor area 201 is provided in half of the rotating plate 100, and the insulator area 202 is provided in the other half.

Since the sensors A and B have the same configuration, the sensor A will first be described in detail. The sensor A has an input node NA1 for receiving an initiation signal I1 from the MCU 800, an output node NA2 for outputting a response signal S1 to the MCU 800, a coil 200A which is arranged over the main surface of the rotating plate 100, a resistance element RA, and a capacitance element CA. The coil 200A is arranged over the main surface of the rotating plate 100 so as not to touch the main surface of the rotating plate 100.

Both the terminals of the capacitance element CA are coupled to the terminals LA1 and LA2 of the coil 200A so that the capacitance element CA is parallely coupled to the coil 200A. The parallel circuit comprised of the capacitance element CA and the coil 200A functions as a passive resonance circuit. In this case, the resonance frequency of the resonance circuit is such a value as to produce resonance between the coil 200A and the insulator area 202 when the insulator area 202 of the rotating plate 100 rotationally moves close to (including “directly under”) the coil 200A. The terminal LA1 of the coil 200A is coupled to the input node NA1, and the terminal LA2 is coupled through the resistance element RA to the output node NA2. The resistance element RA is a current limiting resistor. When the initiation signal I1 is supplied to the input node NA1 from the MCU 800, the resistance element RA prevents a large transient current from flowing through the resonance circuit (the coil 200A and the capacitance element CA) to protect the resonance circuit from damage.

The sensor B has an input node NB1, an output node NB2, a coil 200B, a capacitance element CB, and a resistance element RB. Since the sensor B has the same configuration as the sensor A as described above, the input node NB1, the output node NB2, the coil 200B, the capacitance element CB, and the resistance element RB correspond to the input node NA1, the output node NA2, the coil 200A, the capacitance element CA, and the resistance element RA, respectively. The sensor B differs from the sensor A in that the coil 200B is arranged 90 degrees apart from the coil 200A about the center of the rotating plate 100. Further, an initiation signal I2 from the MCU 800 is supplied to the input node of the sensor B, and a response signal S2 of the sensor B is supplied to the MCU 800 through the output node NB2.

As described later, FIG. 8 shows the voltage waveforms of the initiation signals I1, I2 and the response signals S1, S2 in the portions of the sensors A and B, respectively.

The MCU 800 includes a plurality of function blocks formed in one semiconductor integrated circuit device. FIG. 8 shows only the function blocks related to the embodiment. The function blocks shown in FIG. 8 are divided into a function block corresponding to the sensor A, a function block corresponding to the sensor B, and a function block common to the sensors A and B. The function block corresponding to the sensor A and the function block corresponding to the sensor B have the same configuration.

The function block corresponding to the sensor A has an input/output circuit (I/O) 803A, a timing circuit 802A, a comparison circuit (CMP) 804A, and a digital-analog conversion circuit (DAC, hereinafter referred to as a DA conversion circuit) 805A. The function block corresponding to the sensor B has an input/output circuit (I/O) 803B, a timing circuit 802B, a comparison circuit (CMP) 804B, and a DA conversion circuit (DAC) 805B. In FIG. 8, function blocks denoted by the same reference numeral except suffixes “A” and “B” correspond to each other and have the same configuration. Further, the function block with the suffix “A” corresponds to the sensor A, and the function block with the suffix “B” corresponds to the sensor B. For example, the input/output circuits 803A and 803B correspond to each other and have the same configuration. Further, the function block 803A corresponds to the sensor A, and the function block 803B corresponds to the sensor B.

The function block common to the sensors A and B has a central processing unit (hereinafter referred to as CPU) 801, a rotation number counter 806, a rotation number RAM (random access memory) 807, a clock counter 808, and a one-second measurement timer 809.

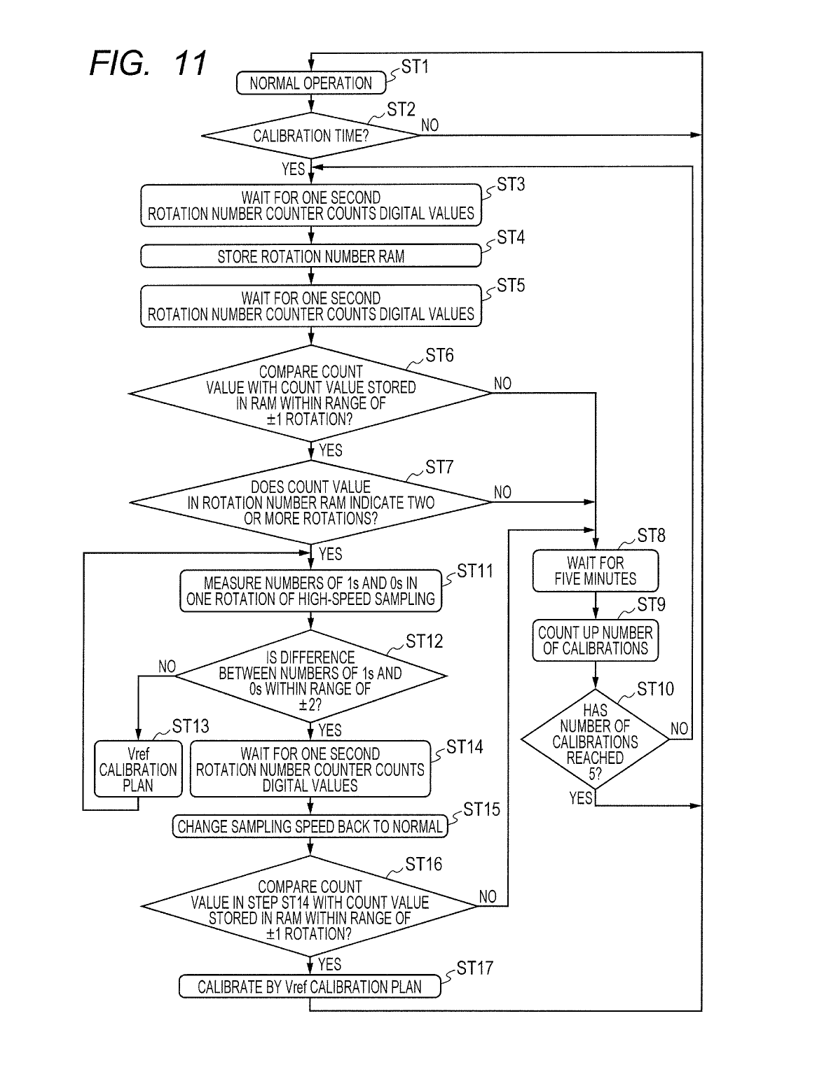

The CPU 801 executes processing described later with FIG. 11, in accordance with a program stored in a memory (not shown). By executing the processing shown in FIG. 11 by the CPU 801, the threshold Vref is calibrated during a calibration duration, and the flow rate of the tap water is measured during a measurement duration. At the time of executing the program, the CPU 801 uses a plurality of registers, among which four registers (RGA1, RGA2, RGB1, RGB2) are shown in FIG. 8. Since the processing executed by the CPU 801 will be described with FIG. 11, only the outline of the function blocks will be described below.

The input/output circuit 803A (803B) functions as an initiation signal generation circuit for supplying the initiation signal I1 (I2) to the input node NA1 (NB1) of the sensor A (B) in accordance with an instruction from the CPU 801. The comparison circuit 804A (804B) receives the response signal S1 (S2) from the output node NA2 (NB2) of the sensor A (B) at one input and receives a voltage from the DA conversion circuit 805A (805B) at the other input to function as a determination circuit. The voltage outputted from the DA conversion circuit 805A is the voltage of the threshold Vref for the sensor A. Similarly, the voltage outputted from the DA conversion circuit 805B is the voltage of the threshold Vref for the sensor B. A digital signal (first control signal, second control signal) corresponding to the threshold Vref is supplied to the DA conversion circuit 805A (805B) from the CPU 801, and the DA conversion circuit 805A (805B) outputs the analog voltage of the threshold Vref converted from the supplied digital signal (control signal). That is, in this embodiment, the digital signal corresponding to the threshold Vref is generated by the CPU 801, and converted by the DA conversion circuit 805A (805B) into the analog voltage of the threshold Vref, which is supplied to the comparison circuit 804A (804B). In other words, the CPU 801 functioning as a control circuit and the DA conversion circuit 805A (805B) can be regarded as a reference value generation circuit for generating the threshold Vref (reference value).

The register RGA1 (RGB1) and the register RGA2 (RGB2) of the CPU 801 are registers for supplying the digital signal to the DA conversion circuit 805A (805B). The register RGA1 (RGB1) and the register RGA2 (RGB2) are selectively switched, and the digital signal is supplied to the DA conversion circuit 805A (805B). That is, during the measurement duration for measuring the flow rate of the tap water, a digital signal stored in the register RGA1 (RGB1) is supplied to the DA conversion circuit 805A (805B), and the analog voltage corresponding to the digital signal is the voltage of the threshold Vref. On the other hand, in the calibration of the voltage value of the threshold Vref, the register RGA2 (RGB2) stores a digital signal and supplies it to the DA conversion circuit 805A (805B).

The digital signal corresponding to the voltage of an appropriate threshold Vref is set in the register RGA1 (RGB1), for example, at the time of shipment of the measurement device. During the calibration duration for calibrating the value of the threshold Vref, the CPU 801 stores the digital signal corresponding to a calibration voltage into the register RGA2 (RGB2). During the calibration duration, the digital signal stored in the register RGA2 (RGB2) is supplied to the DA conversion circuit 805A (805B), and the voltage of the changed threshold Vref is supplied to the comparison circuit 804A (804B). In this embodiment, the voltage of the threshold Vref is changed multiple times during one calibration duration. The digital signal corresponding to the voltage of the post-change threshold Vref is supplied to the register RGA2 (RGB2) from the CPU 801 at each change.

To reflect the voltage value of the threshold Vref changed during the calibration duration as the calibrated voltage value during the measurement duration, the digital signal in the register RGA2 (RGB2) stored during the calibration duration is transferred to the register RGA1 (RGB1). Thereby, the calibrated voltage is used as the voltage of the threshold Vref during the measurement duration. On the other hand, in the case of not reflecting the voltage of the threshold Vref changed during the calibration duration as the calibrated voltage of the threshold Vref, the digital signal in the register RGA2 (RGB2) is not transferred to the register RGA1 (RGB1). Thereby, during the measurement duration, it is possible to use the voltage of the threshold Vref used during the measurement duration preceding the calibration duration. That is, it is possible to continue using the digital signal in the register RGA1 (RGB1) used during the preceding measurement duration.

The timing circuit 802A (802B) specifies timing for operating the comparison circuit 804A (804B), in accordance with an instruction from the CPU 801. For example, during the calibration duration, the comparison circuit 804A (804B) is operated with a predetermined first period, and during the measurement duration, the comparison circuit 804A (804B) is operated with a second period longer than the predetermined first period. Upon receiving an operation instruction from the timing circuit 802A (802B), the comparison circuit 804A (804B) compares the response signal S1 (S2) supplied to one input with the voltage of the threshold Vref supplied to the other input, and supplies the result of the comparison to the rotation number counter 806 as a counting circuit.

The rotation number counter 806 counts the result of the comparison supplied from the comparison circuit 804A (804B) for a duration specified by the CPU 801. For example, if the voltage value of the response signal S1 (S2) is higher than the voltage of the threshold Vref, the comparison circuit 804A (804B) outputs the digital value “1” as the result of the comparison. If the voltage value of the response signal S1 (S2) is lower than the voltage of the threshold Vref, the comparison circuit 804A (804B) outputs the digital value “0” as the result of the comparison. The rotation number counter 806 counts the numbers of digital values “1” and “0” for the duration specified by the CPU 801.

The rotation number RAM 807 is used as a temporary memory used in measuring the number of rotations. The clock counter 808 and the one-second measurement timer 809 will be described with FIG. 11.

In FIG. 8, in the portions of the sensors A and B, the waveforms of the initiation signals I1 and I2 are shown as an initiation signal I1 waveform and an initiation signal I2 waveform, respectively. Similarly, in the portions of the sensors A and B, the waveforms of the response signals S1 and S2 are shown as a response signal S1 waveform and a response signal S2 waveform, respectively. In the initiation signal I1 waveform, the initiation signal I2 waveform, the response signal S1 waveform, and the response signal S2 waveform, the horizontal axis indicates the time, and the vertical axis indicates the voltage. Further, in the response signal S1 waveform and the response signal S2 waveform, Vref denotes the voltage of the threshold Vref, and COM denotes a reference voltage.

The reference voltage COM is determined in consideration of a bias voltage etc. at the input of the comparison circuit 804A (804B). For example, the reference voltage COM may be the ground voltage of the circuit. Further, in the response signal S1 waveform and the response signal S2 waveform, the value of the response signal S1 (S2) is measured at time ts, though not restricted. That is, at time ts, the comparison circuit 804A (804B) compares the voltage of the threshold Vref with the voltage value of the response signal S1 (S2). Further, in the response signal S1 waveform and the response signal S2 waveform shown in FIG. 8, in order to avoid complication of the drawing, time ts is indicated with a point, which is, however, the sampling duration ts having a predetermined time width as shown in FIG. 4.

In accordance with an instruction from the CPU 801, the input/output circuit 803A (803B) supplies a negative-going rectangular pulse as the initiation signal I1 (I2) to the input node NA1 (NB1) of the sensor A (B), as shown by the initiation signal I1 waveform (initiation signal I2 waveform) in FIG. 8. Although not restricted, after generating the rectangular pulse, the input/output circuit 803A (803B) causes the input node NA1 (NB1) to enter a high impedance state. This is achieved by turning off transistors between the input node NA1 (NB1) and the power supply voltage and between the input node NA1 (NB1) and the ground voltage of the circuit. In FIG. 8, the high impedance state is indicated by a broken line.

When the rectangular pulse as the initiation signal I1 (I2) is supplied to the input node NA1 (NB1), the resonance circuit comprised of the capacitance element CA (CB) and the coil 200A (200B) generates the response signal S1 (S2) in response to the initiation signal I1 (I2), and supplies it through the resistance element RA (RB) to the output node NA2 (NB2). The response signal S1 (S2) is the output of the resonance circuit, and damps, fluctuating up and down with respect to the reference voltage COM, as shown by the response signal S1 waveform (response signal S2 waveform) in FIG. 8. The amount of damping changes depending on whether or not the resonance circuit comprised of the coil 200A (200B) and the capacitance element CA (CB) and the area of the rotating plate 100 near the coil 200A (200B) produce resonance.

In this embodiment, the resonance circuit is set to resonate with the insulator area 202. In FIG. 8, the insulator area 202 is located close to (directly under) the coil 200B of the sensor B; accordingly, resonance occurs between the resonance circuit (the capacitance element CB and the coil 200B) of the sensor B and the insulator area 202. This decreases the amount of damping of the response signal S2 at the output node NB2 of the sensor B. On the other hand, the conductor area 201 is located close to (directly under) the coil 200A of the sensor A. Accordingly, resonance does not occur between the resonance circuit (the capacitance element CA and the coil 200A) of the sensor A and the conductor area 201, and energy is rather consumed as eddy current in the conductor area 201. This increases the amount of damping of the response signal S1 at the output node NA2 of the sensor A. As a result, in the example shown in FIG. 8, the amount of damping of the response signal S1 is larger than that of the response signal S2, and the voltage value of the response signal S1 decreases more quickly than that of the response signal S2.

There is a space between the coil 200A (200B) in the sensor A (B) and the rotating plate 100, and the coil 200A (200B) is not directly coupled to the rotating plate 100. However, when the areas 201, 202 having different characteristics (the conductor and the insulator in the embodiment) in the rotating plate 100 get near the coil 200A (200B), the sensor A (B) generates a signal (with a different damping amount/damping time) according to the characteristic of the near area. Therefore, the sensor A (B) can be regarded as being coupled to the rotating plate 100. Further, the sensor A (B) can be regarded as a detection circuit for detecting the rotation of the rotating plate 100.

Although not restricted, in this embodiment, during the duration is provided after a lapse of a predetermined time tp from time t1 at which the response signal S1 (S2) is generated, the comparison circuit 804A (804B) compares the voltage of the threshold Vref with the voltage of the response signal S1 (S2), and supplies the comparison result to the rotation number counter 806.

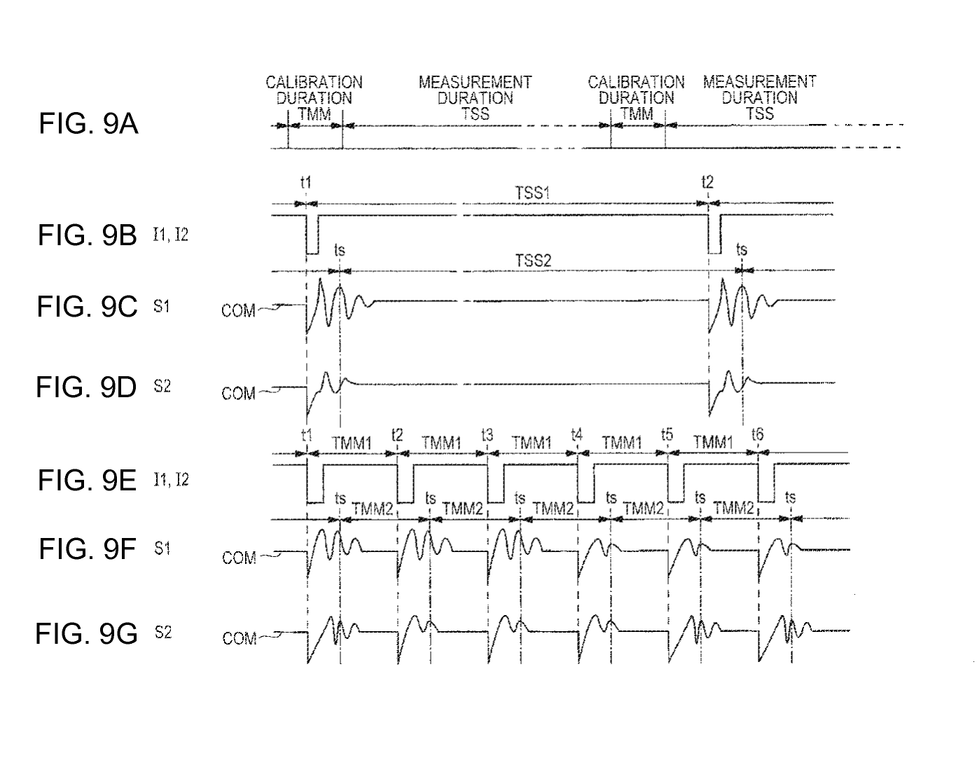

Next, the relationship between the calibration for calibrating the voltage value of the threshold Vref and the measurement duration for measuring the flow rate of the tap water will be described with reference to FIG. 9. FIG. 9 is a waveform diagram showing the voltage waveforms of the initiation signals I1, I2 and the response signals S1, S2 during the calibration duration and the measurement duration. In FIGS. 9A to 9G, the horizontal axis indicates the time, and in FIGS. 9B to 9G, the vertical axis indicates the voltage.

FIG. 9A shows the relationship between the calibration duration TMM and the measurement duration TSS. The calibration of the threshold Vref and the measurement are performed exclusively. In the example of FIG. 9A, the measurement is performed after the calibration is performed, and the measurement duration TSS is provided after the calibration duration TMM. As described with FIG. 6, the calibration is performed during a duration when the flow rate of the tap water is approximately constant. For example, if the flow rate of the tap water is not constant during the preset calibration duration TMM, the result of the calibration performed during the calibration duration TMM is not reflected in the measurement.

During one measurement duration TSS shown in FIG. 9A, the measurement device measures the flow rate of the tap water multiple times. That is, the initiation signals I1, I2 are generated multiple times and supplied to the sensors A, B, and the response signals S1, S2 from the sensors A, B are sampled to measure the number of rotations of the rotating plate 100 and calculate the flow rate. Waveforms corresponding to one generation of the initiation signals I1, I2 in the multiple measurements are shown in FIGS. 9B to 9D. That is, the waveforms shown in FIGS. 9B to 9D are generated multiple times during the measurement duration TSS shown in FIG. 9A. Similarly, during one calibration duration TMM shown in FIG. 9A, the initiation signals I1, I2 are generated multiple times and supplied to the sensors A, B, and the response signals S1, S2 are supplied from the sensors A, B to the MCU 800. That is, during the one calibration duration TMM shown in FIG. 9A, the repetitive waveforms shown in FIGS. 9E to 9G are generated multiple times.

In this embodiment, the calibration duration TMM is set to be sufficiently shorter than the measurement duration TSS, and, to improve the accuracy of the calibration, a period TMM2 (FIGS. 9F, 9G) of the sampling duration ts generated during the calibration duration TMM is set to be shorter than a period TSS2 (FIGS. 9C, 9D) of the sampling duration ts generated during the measurement duration. In accordance therewith, a period TMM1 (FIG. 9E) of the initiation signals I1, I2 generated during the calibration duration is also set to be shorter than a period TSS1 (FIG. 9B) during the measurement duration.

FIG. 9B shows the voltage waveform of the initiation signals I1, I2. The initiation signals I1, I2 are generated at time t1 and time t2. That is, the initiation signals I1, I2 change to negative-going rectangular pulses at time t1 and time t2. In response to the rectangular pulses, the sensor A generates the response signal S1 fluctuating up and down with respect to the reference voltage COM as shown in FIG. 9C, and supplies it to the comparison circuit 804A in the MCU 800 (FIG. 8). Similarly, in response to the rectangular pulses, the sensor B generates the response signal S2 fluctuating up and down with respect to the reference voltage COM as shown in FIG. 9D, and supplies it to the comparison circuit 804B in the MCU 800. During the sampling duration ts, the comparison circuits 804A, 804B compare the voltages of the supplied response signals S1, S2 with the voltage of the threshold Vref from the DA conversion circuits 805A, 805B, and supply the comparison results to the rotation number counter 806.

Timing for changing the voltages of the initiation signals I1, I2 to rectangular pulses, that is, timing for generating the initiation signals I1, I2 is determined by timing when the CPU 801 instructs the input/output circuits 803A, 803B to generate the initiation signals. The initiation signals I1, I2 are set by the CPU 801 so as to be generated with the fixed period TSS1 during the measurement duration TSS. The sampling duration ts is generated in response to the generation of the initiation signals I1, I2. That is, the CPU 801 and the timing circuits 802A, 802B perform control so that the sampling duration ts is generated after a lapse of a predetermined time from the generation of the initiation signals I1, I2 (rectangular pulses). Accordingly, the sampling duration ts is generated multiple times with the fixed period TSS2 during the measurement duration TSS. In other word, the initiation signals I1, I2 and timing for operating the comparison circuits 804A, 804B are synchronized with each other.

FIGS. 9E to 9G show the voltage waveforms of the initiation signals I1, I2 and the response signals S1, S2 during the calibration duration TMM. During the calibration duration TMM, the period of the initiation signals I1, I2 specified from the CPU 801 to the input/output circuits 803A, 803B is set to be shorter than during the measurement duration TSS. Accordingly, the input/output circuits 803A, 803B generate negative-going rectangular pulses as the initiation signals I1, I2 multiple times with the period TMM1 shorter than the period TSS1 of the initiation signals I1, I2 during the measurement duration TSS, as shown in FIG. 9E.

In accordance with the shorter generation period of the initiation signals I1, I2, the CPU 801 also sets the generation period TMM2 of the sampling duration ts to be shorter than the period TSS2 of the sampling duration ts generated during the measurement duration TSS. Accordingly, during the calibration duration TMM, the initiation signals I1, I2 (rectangular pulses) are generated multiple times with the short period TMM1, and in response to the initiation signals I1, I2, the sensors A, B generate the response signals S1, S2 multiple times. The response signals S1, S2 generated multiple times by the sensors A, B are compared with the voltage of the threshold Vref during the sampling duration ts generated multiple times with the short period TMM2. The result of the comparison is supplied to the rotation number counter 806, as during the measurement duration TSS. In FIG. 9 as well, in order to avoid complication of the drawing, the sampling duration ts is indicated as a point, which, however, has the predetermined duration as shown in FIG. 4.

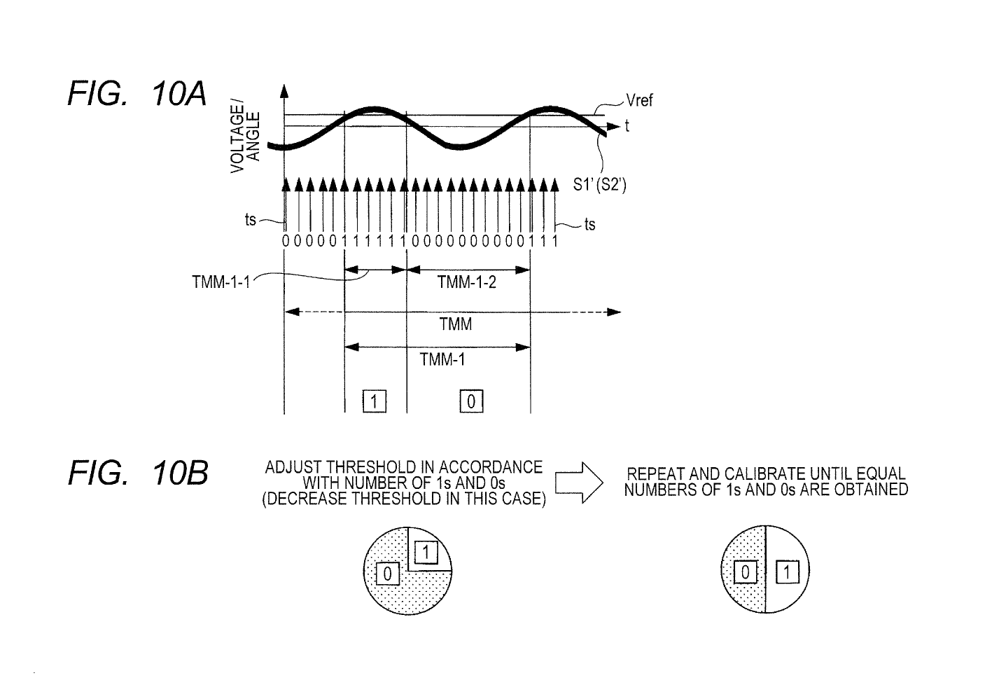

During the calibration duration TMM, the voltage value of the threshold Vref is calibrated. Next, the operation of the calibration will be described with reference to FIG. 10. FIG. 10A is a waveform diagram showing the relationship between a voltage envelope curve S1′ (S2′) about the maximum values of the response signal S1 (S2) during the calibration duration TMM and the sampling duration ts generated with the short period TMM2. FIG. 10B is a diagram showing a change in determination result (“1” corresponding to the insulator area 202, and “0” corresponding to the conductor area 201) by changing the threshold Vref in calibration.

In FIG. 10A, S1′ (S2′) denotes the voltage envelope curve obtained by connecting the maximum values of the response signal S1 (S2) from the sensor A (B), and changes with time. Since the voltage envelope curve S1′ (S2′) can also be regarded as representing the angle of the rotating plate 100, the vertical axis in FIG. 10A indicates the voltage/angle. Further, Vref denotes the voltage of the threshold Vref supplied to the comparison circuit 804A (804B). The rotating plate 100 rotates multiple times during the calibration duration TMM. FIG. 10A shows the change of the voltage envelope curve S1′ (S2′) during and around a specific one rotation. One rotation can be specified, for example, by determining whether the voltage of the voltage envelope curve S1′ (S2′) is rising or falling to match. In FIG. 10A, the specific one-rotation duration is indicated by reference numeral TMM-1.

During the calibration duration TMM, the sampling duration ts is generated with the short period TMM2, as described with FIG. 9. That is, the response signal S1 (S2) is sampled with the period TMM2. In FIG. 10A, the sampling durations ts generated with the period TMM2 are indicate by up-pointing arrows. The result of comparing the response signal sampled during the sampling duration ts with the voltage of the threshold Vref is shown as the digital value “0” or “1” below the corresponding up-pointing arrow. For example, in FIG. 10A, the comparison result in the sampling duration ts indicated by the leftmost up-pointing arrow is the digital value “0”, and the comparison result in the sampling duration ts indicated by the rightmost up-pointing arrow is the digital value “1”. To facilitate visualization, FIG. 10A shows the voltage envelope curve S1′ (S2′) about the maximum values of the response signal S1 (S2) instead of the voltage of the response signal S1 (S2) as the voltage compared with the threshold Vref.

In this embodiment, the voltage of the threshold Vref is maintained or changed in accordance with the comparison result outputted from the comparison circuit 804A (804B) in one rotation of the rotating plate 100. That is, the voltage of the threshold Vref is calibrated so that the number of digital values “1” outputted from the comparison circuit 804A (804B) in one rotation becomes equal to the number of digital values “0”. As a matter of course, if the number of digital values “1” is equal to the number of digital values “0”, the voltage of the threshold Vref is not changed, but is maintained.

In FIG. 10A, the numbers of digital values “1” and “0” outputted from the comparison circuit 804A (804B) during the specific one-rotation duration TMM-1 are obtained. In this example, during the duration TMM-1 corresponding to one rotation, the digital value “1” is outputted from the comparison circuit 804A (or 804B) during a duration TMM-1-1, and the digital value “0” is outputted from the comparison circuit 804A (or 804B) during a duration TMM-1-2. In the example of FIG. 10A, the digital value “1” is outputted six times during the duration TMM-1-1, and the digital value “0” is outputted ten times during the duration TMM-1-2. As a matter of course, the duration TMM-1-1 and the duration TMM-1-2 vary according to the response signal and the voltage of the threshold Vref within a range that the sum of the duration TMM-1-1 and the duration TMM-1-2 is equal to the duration TMM-1 corresponding to one rotation of the rotating plate 100.

In the case where the number of digital values “1” is different from the number of digital values “0” during the one-rotation duration as shown in FIG. 10A, the conductor area 201 (FIG. 2) to be determined as the digital value “0” is different in size from the insulator area 202 (FIG. 2) to be determined as the digital value “1” in the estimation of positions on the main surface of the rotating plate 100 from the comparison result (digital values) of the comparison circuit 804A (804B). That is, if the number of digital values “0” is larger than the number of digital values “1”, it is estimated that the conductor area 201 is larger than the insulator area 202 as shown in the left part of FIG. 10B. In other words, it is estimated that the angle of the insulator area 202 is less than 180 degrees about the center (central shaft 106) of the rotating plate 100.

On the other hand, on the main surface of the rotating plate 100, the conductor area 201 and the insulator area 202 are arranged so as to have an angle of 180 degrees about the center. That is, the area ratio between the conductor area 201 and the insulator area 202 is one to one. On the other hand, the number ratio between the numbers of digital values “0” and “1” as the comparison result of the comparison circuit 804A (804B) is 10 to 6. The voltage value of the threshold Vref is calibrated so that the number ratio becomes equal to the area ratio. In this case, as the voltage of the threshold Vref is increased, the number of digital values “0” outputted from the comparison circuit 804A (804B) increases, and the number of digital values “1” decreases. On the other hand, as the voltage of the threshold Vref is decreased, the number of digital values “1” outputted from the comparison circuit 804A (804B) increases, and the number of digital values “0” decreases. Therefore, in the example shown in FIG. 10A, the voltage of the threshold Vref is decreased. Accordingly, during the one-rotation duration TMM-1, the number of digital values “1” outputted from the comparison circuit 804A (804B) increases, and the number of digital values “0” decreases, thus approaching the one-to-one area ratio.

Although not restricted, in this embodiment, there is limited a voltage range for changing the voltage of the threshold Vref during the duration TMM-1 of one rotation of the rotating plate 100. Therefore, the number ratio between the numbers of digital values “0” and “1” obtained during the one-rotation duration TMM-1 might not become equal to the area ratio by one calibration of the voltage of the threshold Vref. In this case, in the next one-rotation duration TMM-1 during the calibration duration TMM, the number ratio is obtained, and the voltage of the threshold Vref is further changed. By repeating this operation, the voltage of the threshold Vref is changed so that the number ratio becomes equal to the area ratio, that is, the ratio between the conductor area 201 and the insulator area 202 estimated from the comparison result of the comparison circuit becomes equal to the area ratio, as shown in the right part of FIG. 10B. In this embodiment, the conductor area 201 is equal in size to the insulator area 202; accordingly, the calibration is performed so that the number of digital values “0” becomes equal to the number of digital values “1”.

While the description has been made in the case of a larger number of digital values “0” as the comparison result of the comparison circuit 804A (804B) in FIG. 10, in the case of a larger number of digital values “1” as well, the voltage of the threshold Vref is increased so that the number ratio becomes equal to the area ratio.

FIG. 11 is flowchart showing processing executed by the CPU 801 shown in FIG. 8. The CPU 801 performs the same processing on the sensors A and B. Accordingly, by way of example of the sensor A, the processing by the CPU 801 will be described mainly with reference to FIGS. 8, 9, and 11.

First, in step ST1, the flow rate of the tap water is measured. That is, processing during the measurement duration TSS is performed. In step ST1, the CPU 801 instructs the input/output circuit 803A to generate the initiation signal I1 with the period TSS1. In response to this instruction, the input/output circuit 803A supplies the initiation signal I1 with the period TSS1 to the input node NA1 of the sensor A. In response to the initiation signal I1, the sensor A generates the response signal S1 corresponding to the rotation position of the area 201, 202 of the rotating plate 100, and supplies it through the output node NA2 to the comparison circuit 804A. The comparison circuit 804A compares the supplied response signal S1 with the voltage of the threshold Vref supplied from the DA conversion circuit 805A during the sampling duration ts. The digital value generated by this comparison is supplied to the rotation number counter 806.

Further, the CPU 801 controls the comparison circuit 804A, using the timing circuit 802A so that the sampling duration ts is generated after a lapse of a predetermined time from the instruction for generating the initiation signal I1. The comparison circuit 804A starts a comparison operation, for example, by a signal delayed by the timing circuit 802A by the predetermined time from the instruction for generating the initiation signal I1. After a lapse of a predetermined time from the generation of the delayed signal, the timing circuit 802A supplies a signal for stopping the comparison operation to the comparison circuit 804A. Accordingly, the comparison circuit 804A performs the comparison operation during the sampling duration ts, with the period TSS2 corresponding to the period TSS1 of the initiation signal I1.

In step ST1, in the same way as in the sensor A, the initiation signal I2 is supplied to the sensor B, the response signal S2 is supplied to the comparison circuit 804B, and the digital value from the comparison circuit 804B is supplied to the rotation number counter 806.

The rotation number counter 806 counts digital values from the comparison circuits 804A and 804B for a predetermined time, and supplies the result to the CPU 801. The CPU 801 calculates the flow rate of the tap water, based on the number of rotations supplied from the rotation number counter 806 and e.g. the flow rate per rotation. Although not restricted, the flow rate is displayed on the water meter 810 and/or outputted outside the water meter 810.

In step ST2, it is determined whether or not a calibration time is reached. Although not restricted, in this embodiment, the clock counter 808 generates an interrupt signal to the CPU 801 after a lapse of a predetermined time. For example, one hour as the predetermined time is set to the clock counter 808. In step ST2, it is determined whether or not the interrupt signal is supplied from the clock counter 808. If the calibration time is not reached (N), the flow returns to step ST1, and the measurement of the flow rate of the tap water is continued.

In step ST2 if it is determined that the interrupt signal is supplied from the clock counter 808 (Y), then the flow proceeds to step ST3.

In step ST3, the measurement of the flow rate of the tap water is stopped (waited) for one second. This one second is measured by the one-second measurement timer 809. That is, in step ST2 if the supply of the interrupt signal is determined, the one-second measurement timer 809 is activated to start one-second measurement. Further, in step ST3, the rotation number counter 806 counts digital values from the comparison circuit 804A, along with the start of the one-second measurement. The one-second stop in step ST3 means that the value counted by the rotation number counter 806 is not used to measure the flow rate of the tap water. The supply of the initiation signal I1 and the operation in which the comparison circuit 804A obtains the digital value corresponding to the response signal S1 described in step ST1 are continued during the one-second stop. Accordingly, in step ST3 as well, the rotation number counter 806 counts the digital values “1” and “0” generated based on the rotation of the rotating plate 100 for one second.

In step ST4, the number of counts obtained by counting in step ST3 is transferred to the rotation number RAM 807 by the CPU 801, and stored in the rotation number RAM 807. Then, the flow proceeds to step ST5. In step ST5, the measurement of the flow rate of the tap water is stopped (waited) for one second, as in step ST3. In step ST5 as well, the supply of the initiation signal I1 to the sensor A and the acquisition of digital values based on the response signal S1 from the sensor A are continued, as in step ST3. The digital values based on the response signal S1 are counted by the rotation number counter 806. As in step ST3, the value of the rotation number counter 806 counted in step ST5 is not used to measure the flow rate of the tap water.

Then, in step ST6, the CPU 801 compares the count value obtained by counting in step ST5 with the count value stored in the rotation number RAM 807. That is, in step ST6, the count value corresponding to the number of rotations of the rotating plate 100 for one second obtained in step ST3 is compared with the count value corresponding to the number of rotations of the rotating plate 100 for one second obtained in step ST5. As a matter of course, this one second is merely an example, and the invention is not limited thereto.

In the comparison in step ST6, it is determined whether or not the difference in the number of rotations of the rotating plate 100 between the count value stored in the rotation number RAM 807 and the count value obtained in step ST5 is within the range of ±1 rotation. In this comparison, if the difference between the numbers of rotations of the rotating plate 100 is within the range of ±1 rotation (Y), then the flow proceeds to step ST7. If the difference between the numbers of rotations is beyond the range of ±1 rotation (N), then the flow proceeds to step ST8.

In step ST7, it is determined whether or not the count value stored in the rotation number RAM 807 corresponds to two or more rotations of the rotating plate 100. The two rotations are merely an example, and the invention is not limited thereto. In step ST7 if the count value indicates two or more rotations (Y), then the flow proceeds to step ST11. If the count value indicates less than two rotations (N), then the flow proceeds to step ST8.

The comparison in step ST6 is performed to determine whether or not the rotating plate is rotating at approximately constant speed as described with FIG. 6. Further, the comparison in step ST7 is performed to determine whether the rotating plate 100 is rotating and the number of rotations is appropriate in the case where it is determined that the rotating plate is rotating at constant speed. Accordingly, if the number of rotations is not approximately constant (N in step ST6) or if the number of rotations of the rotating plate 100 is not appropriate (N in step ST7), the flow proceeds to step ST8.

In step ST8, the measurement of the flow rate is stopped (waited) for five minutes. In step ST8, the measurement of the flow rate is stopped for five minutes, as in step ST3 or ST5. Unlike in step ST3 or ST5, the generation of the initiation signal I1, the generation of the digital value corresponding to the response signal S1, and counting by the rotation number counter 806 may not be performed or may be performed during the five-minute stop. Further, five minutes are merely an example, and the invention is not limited thereto. Further, five minutes may be measured using the one-second measurement timer 809 or using another timer (not shown).

After the five-minute stop in step ST8, the flow proceeds to step ST9. In step ST9, a calibration number counter (not shown) is counted up. For example, a counter circuit (not shown) provided in the CPU 801 may be used as the calibration number counter, or a specific address of a memory (not shown) in the MCU 800 may be used as the counter.

After step ST9, the flow proceeds to step ST10. In step ST10, it is determined whether or not the count value of the calibration number counter reaches 5. That is, it is determined whether or not the number of calibrations has reached 5. If the number of calibrations does not reach 5 (N), the flow returns to step ST3. If the number of calibrations reaches 5 (Y), the flow returns to step ST1. At the time of returning to step ST1, the calibration number counter is reset in preparation for the next calibration. Accordingly, steps ST3 to ST10 are repeated until the number of calibrations reaches a predetermined number (5 in this example). If the number of calibrations reaches the predetermined number, the calibration is not performed for the next one hour. Thus, by putting the upper limit on the number of calibrations, it becomes possible to prevent the calibration duration from unnecessarily elongating. Further, five minutes in step ST8 and five in step ST10 are merely examples, and the invention is not limited thereto.

In steps ST3 to ST7, if it is determined that the rotation speed of the rotating plate 100 is approximately constant in two or more rotations, the flow proceeds to step ST11. In step ST11, high-speed sampling is performed, and the numbers of digital values “1” and “0” in one rotation of the rotating plate 100 are measured.

In step ST11, the CPU 801 sets the period of the instruction for generating the initiation signal I1 to be shorter than during the measurement duration. That is, the CPU 801 sets the period of the instruction to be shorter than that of the instruction by the CPU 801 for generating the initiation signal I1 in step ST1. Accordingly, the input/output circuit 803A generates the rectangular pulse with the period TMM1, as described with FIG. 9.

Further, the period of the instruction supplied from the CPU 801 to the timing circuit 802A is set to be shorter, as in the case of the instruction for generating the initiation signal I1. Accordingly, the timing circuit 802A supplies a control signal to the comparison circuit 804A so that the sampling duration ts is generated with the short period TMM2, as described with FIG. 9. Accordingly, the comparison circuit 804A compares the response signal S1 with the voltage of the threshold Vref from the DA conversion circuit 805A during the sampling duration ts generated with the short period TMM2, as described with FIG. 9. The response signal S1 is generated in response to the initiation signal I1 of the rectangular pulse generated with the short period TMM1.

The response signal S1 generated based on the initiation signal I1 of the rectangular pulse generated with the short period TMM1 is compared with the voltage of the threshold Vref by the comparison circuit 804A, and thereby converted into the digital value “1”, “0”. The rotation number counter 806 counts the converted digital values “1”, “0”, separately. The CPU 801 acquires, from the rotation number counter 806, the number of digital values “1” and the number of digital values “0” during the duration TMM-1 (FIG. 10) of one rotation of the rotating plate 100.

In step ST12, the CPU 801 determines whether or not the difference between the number of digital values “1” and the number of digital values “0” acquired in step ST11 is within a predetermined range. In this example, the predetermined range is ±2. That is, the CPU 801 determines whether or not the difference between the number of digital values determined as “1” and the number of digital values determined as “0” is within the range of ±2. If the result of the determination is beyond the range of ±2 (N), then the flow proceeds to step ST13. If the result of the determination is within the range of ±2 (Y), then the flow proceeds to step ST14.

In step ST13, the voltage of the threshold Vref is changed, as described with FIG. 10. In this embodiment, the voltage of the threshold Vref is generated by the DA conversion circuit 805A. Accordingly, the CPU 801 generates a digital signal corresponding to the voltage of the change threshold Vref, stores it in the register RGA2, and changes the register for supplying the digital signal to the DA conversion circuit 805A, from the register RGA1 to the register RGA2. Accordingly, a calibration plan of the voltage of the threshold Vref is created and stored in the register RGA2, and the threshold Vref of the voltage corresponding to the calibration plan is supplied from the DA conversion circuit 805A to the comparison circuit 804A.

In a state where the threshold Vref of the voltage corresponding to the calibration plan is supplied to the comparison circuit 804A, the flow returns to step ST11. In step ST11, the initiation signal is generated with the short period TMM1, sampling is performed with the short period TMM2, and the respective numbers of digital values “1” and “0” during the duration TMM-1 corresponding to one rotation are counted. Then, in step ST12, it is determined again whether or not the difference between the determination number of digital values “1” and the determination number of digital values “0” is within the predetermined range. In step ST12 if it is determined again that the difference is not within the predetermined range, in step ST13 a calibration plan of the threshold Vref is created and stored in the register RGA2. In this case, the register for supplying the digital signal to the DA conversion circuit 805A has already been switched to the register RGA2; therefore, register switching is not performed. Thus, steps ST11 to ST13 are repeated until the difference between the numbers of digital values “1” and “0” falls within the predetermined range. Thereby, the voltage of the threshold Vref is calibrated so that the area ratio between the area 202 and the area 201 of the rotating plate 100 and the number ratio between the numbers of digital values “0” and “1” fall within the predetermined range, as described with FIG. 10. In this embodiment, the area ratio is one to one; accordingly, the voltage of the threshold Vref is calibrated so that the number ratio falls within the range of ±2. While the predetermined range is ±2 in this example, the invention is not limited thereto. Further, the value of the threshold Vref may be calibrated until the number ratio becomes equal to the area ratio.

In step ST12 if the difference between the numbers falls within the range of ±2, the flow proceeds to step ST14. In step ST14, although not restricted, the measurement of the flow rate is stopped for one second to obtain the number of rotations of the rotating plate 100, as in steps ST3, ST5. Although not restricted, in this embodiment, in step ST14, the number of rotations of the rotating plate 100 is obtained with the short period of the initiation signal I1 and the short sampling period. One rotation of the rotating plate 100 can be obtained from the response signal S1 as described with FIG. 10, and the number of rotations of the rotating plate 100 is obtained in step ST14. At this time, the voltage value of the threshold Vref supplied to the comparison circuit 804A to convert the response signal S1 into the digital value is the calibrated voltage. That is, the voltage corresponding to the digital value stored in the register RGA2 is supplied as the calibrated voltage to the comparison circuit 804A.

Then, the flow proceeds to step ST15. In step ST15, the CPU 801 sets the period of the instruction for generating the initiation signal I1 to the same as in step ST1. Accordingly, the input/output circuit 803A generates the initiation signal I1 of the rectangular pulse with the period TSS1, and supplies it to the sensor A. Along with the longer period TSS1 of the initiation signal I1, the CPU 801 sets the period of the instruction provided to the timing circuit 802A to be longer. Accordingly, the timing circuit 802A generates a control signal for generating the sampling duration is with the long period TSS2, and supplies it to the comparison circuit 804A. Thus, the period of the initiation signal I1 and the sampling period are returned to the state in step ST1 (the sampling speed is changed back to normal).

Then, the flow proceeds to step ST16. In step ST16, the count value corresponding to the number of rotations of the rotating plate 100 obtained in step ST14 is compared with the count value corresponding to the number of rotations stored in the rotation number RAM 807. By this comparison, it is determined whether or not the difference between the two count values is within the range of ±1 rotation.

In step ST16 if the difference is beyond the range of ±1 rotation (N), it is determined that the rotation speed of the rotating plate 100 is not approximately constant, the flow proceeds to step ST8. In this case, the register for supplying the digital signal to the DA conversion circuit 805A is changed from the register RGA2 to the register RGA1. Based on the digital signal stored in the register RGA1, the voltage of the threshold Vref is generated by the DA conversion circuit 805A. Then, in step ST9, the number of calibrations is counted up, and in step ST10, the comparison of the number of calibrations is performed. In step ST10 if the number of calibrations does not reach 5, the flow returns to step ST3. If the number of calibrations reaches 5, the calibration is postponed to the next time.

On the other hand, in step ST16 if the difference is within the range of ±1 rotation (Y), then the flow proceeds to step ST17. In step ST17, the threshold Vref is calibrated by the calibration plan. That is, the digital value stored in the register RGA2 is transferred to the register RGA1, and the register for supplying the digital signal to the DA conversion circuit 805A is switched from the register RGA2 to the register RGA1. Thereby, the voltage of the appropriate calibrated threshold Vref is outputted from the DA conversion circuit 805A. Then, the flow returns to step ST1, and the measurement of the flow rate of the tap water is started. At this time, the calibrated voltage is used as the voltage of the threshold Vref compared with the response signal S1.

While the description has been made by way of example of the sensor A, the above steps ST1 to ST17 are also performed on the sensor B, and the voltage value of the threshold Vref is calibrated.

In this embodiment, the number of rotations is obtained with the calibrated voltage as the voltage of the threshold Vref in step ST14 before the sampling speed is changed back to normal in step ST15. However, steps ST14 and ST15 may be interchanged. That is, after the sampling speed is changed back to normal, the number of rotations may be counted for one second. Thus, it can also be determined whether or not the rotation speed of the rotating plate 100 has changed beyond expectation during the calibration duration for calibration operation, which can prevent the calibration plan from being applied if the rotation speed has changed.

By setting an appropriate value in the register RGA1 (RGB1), for example, at the time of shipment of the measurement device; even if the voltage value of the threshold Vref changes due to voltage change, characteristic change, or temporal change, the appropriate voltage value can be obtained by calibrating the voltage of the threshold Vref.

In this embodiment, in the sensors A and B, the threshold Vref is calibrated so that the number ratio matches the area ratio, based on the response signals S1, S2. Therefore, it is possible to calibrate the threshold Vref in accordance with respective changes in characteristics of the sensors A and B.

Further, due to the use of the two sensors, it can be determined whether the rotating plate 100 is rotating in a clockwise or counterclockwise direction, based on the respective outputs of the sensors A and B. This makes it possible to detect that the rotating plate 100 rotates in an undesired direction due to a leak from the water pipe and/or an abrupt stop of tap water, and therefore enhance the measurement reliability of the water meter.

### Modification

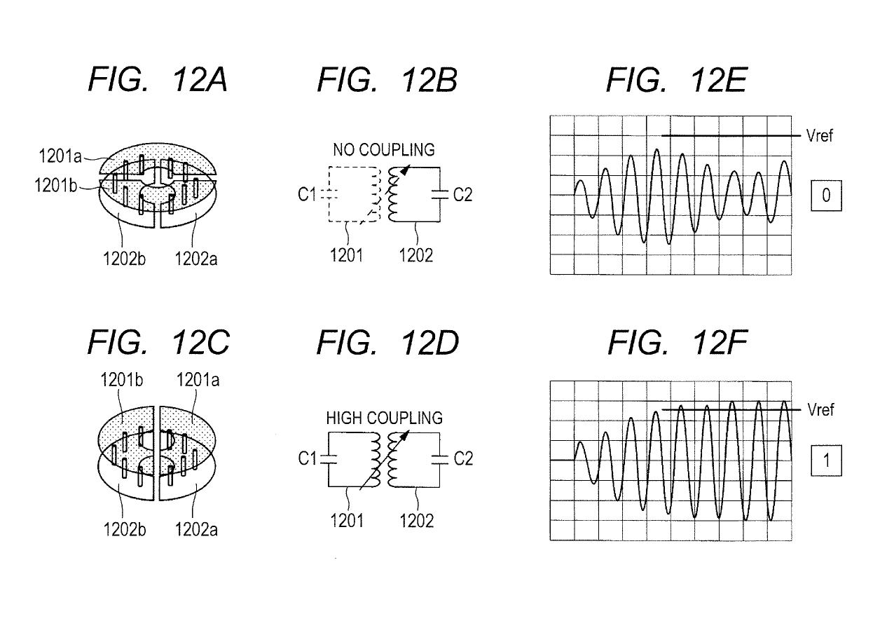

While the description has been made by way of example of the rotating plate where the conductor area and the insulator area are arranged and the sensors using the coils as the embodiment, the invention is not limited thereto. For example, a sensor shown in FIGS. 12A and 12B may be used. In this case, the rotating plate 100 has a semicircular coil unit 1201a and a semicircular coil unit 1201b arranged on the same plane as the coil unit 1201a and arranged with an insulating area between the semicircular coil units 1201a and 1201b. The sensor has a semicircular coil unit 1202a and a semicircular coil unit 1202b arranged on the same plane as the coil unit 1202a and arranged with an insulating area between the semicircular coil units 1202a and 1202b.

The semicircular coil units 1201a and 1201b configuring the rotating plate 100 rotate in accordance with the flow of the tap water. The semicircular coil units 1201a and 1201b are coupled to a capacitance element C1, and the coil units 1201a, 1201b, and the capacitance element C1 in parallel configure a resonance circuit 1201. Further, the semicircular coil units 1202a and 1202b in the sensor are coupled to a capacitance element C2, and the coil units and the capacitance element C2 in parallel configure a resonance circuit 1202. In this case, parasitic capacitance elements may be used as the capacitance elements C1, C2.

By rotation of the upper rotating plate as shown in FIGS. 12A and 12B, electromagnetic coupling between the semicircular coil unit 1201a (1201b) of the rotating plate and the semicircular coil unit 1202a (1202b) of the sensor changes between no coupling and high coupling, as shown in FIGS. 12C and 12D. By periodically supplying the initiation signal to the semicircular coil unit 1202a (1202b) of the sensor, resonance can occur in high coupling and cannot occur in no coupling.

The voltage amplitude of the response signal changes depending on whether or not the resonance occurs. The amplitude of the response signal and the voltage of the threshold Vref are compared to determine the digital values “1” and “0”. In FIG. 12E, the resonance does not occur, and the amplitude of the response signal waveform damps and is lower than the voltage of the threshold Vref. For example, this state is determined as the digital value “0”. Further, in FIG. 12F, the resonance occurs, and the amplitude of the response signal waveform is higher than the voltage of the threshold Vref. This state is determined as the digital value “1”.

In this case as well, the voltage of the appropriate threshold Vref can be set by adjusting the voltage of the threshold Vref so that the number of digital values determined as “1” becomes equal to the number of digital values determined as “0”. Further, in this modification, it is determined only whether or not the amplitude of the response signal exceeds the voltage of the threshold Vref, which facilitates setting of the duration for sampling the response signal.

While, in the embodiment, half the area of the rotating plate 100 is the conductor area 201 and the other half is the insulator area 202, the invention is not limited thereto. For example, one-third the area of the rotating plate 100 may be the conductor area 201, and the other two-thirds may be the insulator area 202. In this case, the area ratio between the conductor area 201 and the insulator area 202 is 1 to 2; accordingly, the voltage of the threshold Vref is calibrated so that the ratio between the determination numbers of digital signals “0” and “1” approaches 1 to 2. As a matter of course, the conductor area 201 may be determined as the digital value “1”, and the insulator area 202 may be determined as the digital value “0”.

Further, while the time interval between calibration durations is set to one hour as described with FIG. 11, the invention is not limited thereto. Since there is little temperature change in the water meter, the time interval between calibration durations may be set to, for example, one day. Further, in the case of the water meter, at the time of monthly bill collection, a bill collector may instruct the water meter to perform a calibration, through a switch or a communication device. Furthermore, the calibration may be performed when measurement is started after the calibration has not been performed for a long time such as one month or more.

In the case where hot water is measured, that is, the flow rate of the hot water is measured by a hot water meter, since large temperature changes can occur, for example when a temperature sensor detects a temperature difference of 20 degrees or more, the calibration may be performed. In this case, if the temperature sensor is provided beforehand in the hot water meter, it may be used, or a new temperature sensor may be provided.

In the embodiment, the sensor detects whether or not the resonance occurs by the rotation of the rotating plate. Therefore, the sensor can also be regarded as outputting the response signal as the presence or absence of resonance.

While, in the embodiment shown in FIG. 11, the number ratio is obtained in one rotation of the rotating plate, the number ratio between the numbers of digital values “1” and “0” may be obtained in multiple rotations. Further, since the input/output circuit 803A (803B) functioning as the initiation signal generation circuit only supplies the initiation signal to the sensor A (B), it may be an output circuit. Further, while the description has been made by way of example of the negative-going rectangular pulse as the initiation signal I1 (I2), the invention is not limited thereto, and for example, a positive-going rectangular pulse may be used.

Further, the circular plate 101 described with FIG. 1 may be a gear wheel provided outside the water pipe 103. In this case, the circular plate 102 may also be a gear wheel, and the gear wheel (circular plate) 101 and the gear wheel (circular plate) 102 may engage with each other.

While the invention made above by the present inventors has been described specifically based on the illustrated embodiments, the present invention is not limited thereto, and various changes and modifications can be made thereto without departing from the spirit and scope of the invention.

What is claimed is:

1. A rotation number measurement device which is coupled to a rotator including first and second areas having different characteristics and measures the number of rotations of the rotator, the rotation number measurement device comprising:
a detection circuit for generating a signal that differs depending on whether the first area is near or the second area is near by rotation of the rotator;
a determination circuit which receives the signal generated by the detection circuit and a reference value and determines the signal based on the reference value;
a counting circuit for obtaining a count indicating that a determination performed by the determination circuit with a first period during a first duration is a signal corresponding to the first area; and
a reference value generation circuit for generating the reference value so that a ratio between a count indicating that a determination performed by the determination circuit with the first period during the first duration is a value of a signal corresponding to the second area and the count obtained by the counting circuit becomes equal to a ratio between the second area and the first area,
wherein the rotation number measurement device determines a signal generated by the detection circuit, using the reference value generated by the reference value generation circuit and calculates the number of rotations of the rotator during a second duration different from the first duration.

2. The rotation number measurement device according to claim 1,
wherein the determination circuit performs a determination with a second period longer than the first period, during the second duration.

3. The rotation number measurement device according to claim 2,
wherein the detection circuit has first and second sensors arranged so as to form a predetermined angle therebetween about a central shaft of the rotator,
wherein the determination circuit has a first comparison circuit for receiving a response signal from the first sensor and a second comparison circuit for receiving a response signal from the second sensor,
wherein the counting circuit has a counter for counting output of the first comparison circuit and output of the second comparison circuit,
wherein the reference value generation circuit has a control circuit for generating a first control signal and a second control signal for determining the reference value supplied to the first comparison circuit and the second comparison circuit based on a value of the counter and a timing circuit for determining timing for operating the first comparison circuit and the second comparison circuit, and
wherein the timing circuit operates the first and second comparison circuits with the first period during the first duration and with the second period during the second duration.

4. The rotation number measurement device according to claim 3,
wherein the rotation number measurement device has an initiation signal generation circuit for supplying an initiation signal to the first sensor and the second sensor in synchronization with the timing for operating the first comparison circuit and the second comparison circuit, and
wherein the reference value generation circuit has a digital-analog conversion circuit which receives the first control signal and the second control signal generated by the control circuit and generates the reference value supplied to the first comparison circuit and the second comparison circuit.

5. The rotation number measurement device according to claim 4,
wherein the rotation number measurement device obtains a rotation direction of the rotator based on output of the first sensor and the second sensor.

6. The rotation number measurement device according to claim 5,
wherein the determination circuit, the counting circuit, and the reference value generation circuit are included in one semiconductor integrated circuit device.

7. The rotation number measurement device according to claim 6,
wherein the rotator is a disc-shaped rotating plate, a half area of a main surface of the rotating plate is the first area, and the other half area is the second area, and
wherein the reference value generation circuit generates such a reference value that a count indicating a signal corresponding to the first area becomes equal to a count indicating a signal corresponding to the second area.

8. A rotation number measurement method for measuring the number of rotations of a rotator including first and second areas having different characteristics, the rotation number measurement method having a calibration duration for calibration and a measurement duration for measurement after the calibration duration, and comprising the steps of:
during the calibration duration,
determining whether or not a signal generated by rotation of the rotator is a signal corresponding to the first area based on a reference value with a first period;
obtaining the number of determinations of the signal corresponding to the first area;
determining whether or not the signal generated by rotation of the rotator is a signal corresponding to the second area based on the reference value with the first period;
obtaining the number of determinations of the signal corresponding to the second area;
calibrating the reference value so that a ratio between the obtained number of determinations corresponding to the first area and the obtained number of determinations corresponding to the second area corresponds to a ratio between the first area and the second area; and
during the measurement duration,
determining a signal generated by rotation of the rotator based on the reference value calibrated during the calibration duration and calculating the number of rotations of the rotator.

9. The rotation number measurement method according to claim 8, comprising the step of determining the signal generated by rotation of the rotator based on the reference value with a period longer than the first period, during the measurement duration.

10. The rotation number measurement method according to claim 9, wherein if a change in the number of rotations of the rotator is within a predetermined range during the calibration duration, the calibrated reference value is set as a reference value during the measurement duration.

11. The rotation number measurement method according to claim 10,
wherein the rotator is a disc-shaped rotating plate, a half area of a main surface of the rotating plate is the first area, the other half is the second area, and
wherein the reference value is calibrated so that the obtained number of determinations corresponding to the first area becomes equal to the obtained number of determinations corresponding to the second area.

12. A flow rate measurement device comprising:
a disc-shaped rotating plate which includes first and second areas having different characteristics and rotates in accordance with a flow of fluid;
a sensor for generating a signal that differs depending on whether the first area is near or the second area is near by rotation of the rotating plate;
a determination circuit which receives the signal generated by the sensor and a reference value and determines the signal based on the reference value;
a counting circuit for obtaining a count indicating that a determination performed by the determination circuit with a first period during a first duration is a signal corresponding to the first area; and
a reference value generation circuit for generating the reference value so that a ratio between a count indicating that a determination performed by the determination circuit with the first period during the first duration is a signal corresponding to the second area and the count obtained by the counting circuit becomes equal to a ratio between the second area and the first area,
wherein the flow rate measurement device determines a signal generated by the sensor, using the reference value generated by the reference value generation circuit and calculates a flow rate of the fluid during a second duration different from the first duration.

13. The flow rate measurement device according to claim 12, wherein the determination circuit performs a determination with a second period longer than the first period, during the second duration.

14. The flow rate measurement device according to claim 13,
wherein the sensor has first and second sensors arranged so as to form a predetermined angle therebetween about a central shaft of the rotating plate,
wherein the determination circuit has a first comparison circuit for receiving a response signal from the first sensor and a second comparison circuit for receiving a response signal from the second sensor,
wherein the counting circuit has a counter for counting output of the first comparison circuit and output of the second comparison circuit,
wherein the reference value generation circuit has a control circuit for generating a first control signal and a second control signal for determining the reference value supplied to the first comparison circuit and the second comparison circuit based on a value of the counter and a timing circuit for determining timing for operating the first comparison circuit and the second comparison circuit, and
wherein the timing circuit operates the first comparison circuit and the second comparison circuit with the first period during the first duration and with the second period during the second duration.

15. The flow rate measurement device according to claim 14,
wherein the flow rate measurement device has an initiation signal generation circuit for supplying an initiation signal to the first and second sensors in synchronization with the timing for operating the first and second comparison circuits, and
wherein the reference value generation circuit has a digital-analog conversion circuit which receives the first and second control signals generated by the control circuit and generates the reference value supplied to the first and second comparison circuits.

16. The flow rate measurement device according to claim 15, wherein the flow rate measurement device obtains a flow direction of the fluid based on output of the first sensor and the second sensor.

17. The flow rate measurement device according to claim 16, wherein the determination circuit, the counting circuit, and the reference value generation circuit are included in one semiconductor integrated circuit device.

18. The flow rate measurement device according to claim 17,
wherein a half area of a main surface of the rotating plate is the first area, and the other half area is the second area, and
wherein the reference value generation circuit generates such a reference value that a count indicating a signal corresponding to the first area becomes equal to a count indicating a signal corresponding to the second area.

19. The flow rate measurement device according to claim 18, wherein the fluid is tap water, and the flow rate measurement device is a water meter.
